(19) United States
(12) Patent Application Publication
(10) Pub. No.: US 2022/0213601 A1
(43) Pub. Date: Jul. 7, 2022

(54) METHOD FOR ADHERING NOBLE METAL TO CARBON STEEL MEMBER OF NUCLEAR POWER PLANT AND METHOD FOR PREVENTING ADHESION OF RADIONUCLIDES TO CARBON STEEL MEMBER OF NUCLEAR POWER PLANT

(71) Applicant: Hitachi-GE Nuclear Energy, Ltd., Hitachi-shi (JP)

(72) Inventors: Ryo HAMADA, Tokyo (JP); Tsuyoshi ITO, Tokyo (JP); Hideyuki HOSOKAWA, Tokyo (JP); Nobuyuki OTA, Hitachi-shi (JP); Mayu SASAKI, Hitachi-shi (JP)

(21) Appl. No.: 17/143,288

(22) Filed: Jan. 7, 2021

(30) Foreign Application Priority Data
Jan. 16, 2020 (JP) 2020-005023

(51) Int. Cl. C23C 18/34; C23C 18/16

(52) U.S. Cl. CPC C23C 18/34; C23C 18/1637

(57) ABSTRACT

A film-forming apparatus is connected to a carbon steel cleanup system pipe of a BWR plant. Formic acid and hydrogen peroxide are injected into the circulation pipe of the film-forming apparatus. An iron elution accelerator aqueous solution containing 3000 ppm of formic acid and 1500 ppm of hydrogen peroxide is brought into contact with the inner surface of the cleanup system pipe, and Fe2+ is eluted from the cleanup system pipe by formic acid, and hydroxyl radicals generated from hydrogen peroxide. The film-forming aqueous solution produced from the iron elution accelerator aqueous solution by injecting the nickel formate aqueous solution is brought into contact with the inner surface of the cleanup system pipe, and the Ni ions incorporated into the inner surface by the substitution reaction are reduced by the electrons generated at the time of elution of Fe2+ to form a Ni metal film on the inner surface thereof.

### CLAIM OF PRIORITY

The present application claims priority from Japanese Patent application serial no. 2020-005023, filed on Jan. 16, 2020, the content of which is hereby incorporated by reference into this application.

### BACKGROUND OF THE INVENTION

### 1. Field of the Invention

The present invention relates to a method for adhering noble metal to a carbon steel member of a nuclear power plant and a method for preventing the adhesion of radionuclides to a carbon steel member of a nuclear power plant, and particularly relates to a method for adhering noble metal to a carbon steel member of a nuclear power plant and a method for preventing the adhesion of radionuclides to a carbon steel member of a nuclear power plant, which are suitable for a boiling-water nuclear power plant.

### 2. Description of Related Art

For example, a boiling-water nuclear power plant (hereinafter referred to as “BWR plant”) includes a nuclear reactor including a built-in core in a reactor pressure vessel (hereinafter referred to as “RPV”). The reactor water supplied to the core by a recirculation pump (or an internal pump) is heated by the heat generated by the fission of the nuclear fuel material in the fuel assemblies loaded in the core and a part thereof becomes steam. The steam is guided from the RPV to the turbine to rotate the turbine. The steam discharged from the turbine is condensed by the condenser to become water. The water is supplied to the reactor as feedwater. In the feedwater, in order to prevent the generation of radioactive corrosion products in the RPV, metal impurities are mainly removed by filtration demineralization equipment provided in the feedwater pipe. The reactor water refers to the cooling water existing in the RPV.

Since the corrosion products that are the source of radioactive corrosion products are generated on the surface of the component members of the BWR plant such as RPV and recirculation system pipes that contact the reactor water, stainless steel, nickel-based alloy, and the like which are less corroded are used for the main component members of the primary system. The RPV made of low alloy steel is overlaid with stainless steel on the inner surface thereof to prevent the low alloy steel from coming into direct contact with the reactor water. The filtration demineralization equipment of the reactor cleanup system purifies apart of the reactor water and actively removes metal impurities slightly contained in the reactor water.

However, even if the above-mentioned corrosion prevention measures are taken, the presence of a very small amount of metal impurities in the reactor water is unavoidable. Therefore, a part of metal impurities as metal oxides adheres to the surface of the fuel rods included in the fuel assembly. The metal elements contained in the metal impurities adhering to the surface of the fuel rods cause a nuclear reaction by irradiation with neutrons emitted from the nuclear fuel material in the fuel rods and become radionuclides such as cobalt-60, cobalt-58, chromium-51, manganese-54, and the like. Most of these radionuclides remain adhered to the fuel rod surface in the form of oxides, while some radionuclides are eluted as ions in the reactor water depending on the solubility of the oxides incorporated or re-released into the reactor water as an insoluble solid called a clad. Radioactive material in the reactor water is removed by the reactor cleanup system. However, the radioactive material that has not been removed is accumulated on the surface of the component members that contact the reactor water while circulating in the recirculation system or the like together with the reactor water. As a result, radiation is radiated from the surface of the component members, which causes radiation exposure of the worker during the regular inspection work. The exposure dose of the worker is controlled so as not to exceed the regulation value for each person. In recent years, the regulation value has been lowered and it has been required to reduce the exposure dose of each person as economically as possible.

A chemical decontamination method has been proposed in which an oxide film containing radionuclides such as cobalt-60 and cobalt-58, formed on the surface of a structural member, for example, a pipe, of a nuclear power plant that has experienced operation is removed by dissolution using chemicals (JP-A-2000-105295).

Various methods for reducing the adhesion of radionuclides to the pipe are being studied. For example, JP-A-2006-38483 proposes a method for preventing the adhesion of radionuclides to the surface of a structural member after the operation of the nuclear power plant by forming a magnetite film, which is a kind of ferrite film, on the surface of the structural member of the nuclear power plant, which contacts the reactor water, after chemical decontamination.

A method has been proposed in which a nickel metal film is formed on the surfaces of carbon steel members, a nickel ferrite film is formed on the surface of the nickel metal film using a film-forming liquid which contains nickel ions, iron (II) ions, an oxidizing agent and a pH adjusting agent, has a pH in the range of 5.5 to 9.0, and has a temperature in the range of 60° C. to 100° C., and then the nickel metal film is converted into a nickel ferrite film with high-temperature water (For example, JP-A-2011-32551).

JP-A-2010-127788 describes that when the ferrite film is formed on the surfaces of the component members of the nuclear power plant, which contact the reactor water, the amount of the formed ferrite film is measured by a crystal oscillator electrode device and the completion of the formation of the ferrite film on the surface of the component members is determined based on the measured amount of the formed ferrite film.

JP-A-2015-158486 describes that when noble metal adheres to the inner surface of a recirculation system pipe which is a component member of a BWR plant, an aqueous solution containing a complex ion forming agent, noble metal ions, and a reducing agent is brought into contact with the inner surface of the recirculation system pipe.

JP-A-2018-48831 describes that a nickel metal film is formed on the surfaces of carbon steel members that contact reactor water, noble metal adheres to the surface of the nickel metal film, and the surface of the nickel metal film to which the noble metal has adhered is brought into contact with oxygen-containing water at 200° C. or higher, thereby converting the nickel metal film into a stable nickel ferrite film (nickel ferrite film in which x is 0 in Ni₁₋ₓFe₂₊ₓO₄) that covers the surface of the carbon steel member and does not elute even by the action of the noble metal.

### SUMMARY OF THE INVENTION

In JP-A-2018-48831, the nickel metal film which has been formed on the surface of the carbon steel members that contact the reactor water to cover the surface thereof and noble metal has adhered thereto is converted into a stable nickel ferrite film (for example, NiFe₂O₄ film) that covers the surfaces of the carbon steel members and does not elute by the action of the noble metal, thereby preventing the adhesion of radionuclides to a carbon steel member of a nuclear plant for a long period of time.

The time required for the noble metal adhesion work from the start of preparation for the formation of a nickel metal film on the surfaces of carbon steel members to the end of the adhesion of noble metal to the formed nickel metal film surface is desired to further shorten than the method of adhering noble metal to a carbon steel member of a nuclear power plant, which is described in JP-A-2018-48831.

An object of the present invention is to provide a method for adhering noble metal to a carbon steel member of a nuclear power plant and a method for preventing the adhesion of radionuclides to a carbon steel member of a nuclear power plant, which can further shorten the time required for the work of adhering noble metal to carbon steel members.

The feature of the present invention that achieves the above-mentioned object is that a film-forming liquid containing an iron elution accelerator containing an iron elution agent and hydrogen peroxide, and nickel ions is brought into contact with a first surface of a carbon steel member of a nuclear power plant that contacts reactor water to form a nickel metal film on the first surface, and noble metal adheres to a second surface of the formed nickel metal film, in which the formation of the nickel metal film and the adhesion of the noble metal are performed after the stop of the operation of the nuclear power plant and before the start of the nuclear power plant.

According to the present invention, the amount of iron ions eluted from a carbon steel member increases by the action of hydroxyl radicals generated from hydrogen peroxide by the catalytic action of iron ions eluted from the carbon steel member by the action of the iron elution agent contained in the iron elution accelerator, and thus, the amount of electrons generated also increases as the amount of iron ions eluted increases. Therefore, the amount of nickel ions that have been incorporated into the surface of the carbon steel member are reduced to the nickel metal by the above electrons also increases. Therefore, the formation of the nickel metal film on the surface of the carbon steel member is promoted and the time required for forming the nickel metal film is remarkably shortened. Since iron ions can be eluted from the carbon steel member even by the generated hydroxyl radicals, the concentration of the iron elution agent in the film-forming liquid can be reduced. As a result, the time required for the decomposition of the iron elution agent can be shortened. Therefore, the time required for the work of adhering the noble metal to carbon steel members in the nuclear power plant can be further shortened.

According to the present invention, the time required for the work of adhering noble metal to a carbon steel member of a nuclear power plant can be further shortened.

### BRIEF DESCRIPTION OF THE DRAWINGS

FIG. 1 is a flowchart showing a procedure of a method for adhering noble metal to a carbon steel member of a nuclear power plant of Example 1, which is a preferred embodiment of the present invention and applied to a cleanup system pipe of a boiling-water nuclear power plant;

FIG. 2 is an explanatory diagram showing a state in which a film-forming apparatus used when performing the method for adhering noble metal to a carbon steel member of a nuclear power plant of Example 1 is connected to a cleanup system pipe of a boiling-water nuclear power plant;

FIG. 3 is a detailed configuration diagram of the film-forming apparatus shown in FIG. 2;

FIG. 4 is a cross-sectional view of the cleanup system pipe of the boiling-water nuclear power plant before the method for adhering noble metal to a carbon steel member of a nuclear power plant shown in FIG. 1 is started;

FIG. 5 is an explanatory diagram showing a state in which a nickel metal film is formed on the inner surface of the cleanup system pipe by the method for adhering noble metal to a carbon steel member of a nuclear power plant shown in FIG. 1;

FIG. 6 is an explanatory diagram showing a state in which noble metal adheres to the surface of the nickel metal film formed on the inner surface of the cleanup system pipe by the method for adhering noble metal to a carbon steel member of a nuclear power plant shown in FIG. 1;

FIG. 7 is an explanatory diagram showing the formation amount of the nickel metal film formed on each of a carbon steel test specimen whose surface is not treated with an iron elution accelerator, a carbon steel test specimen whose surface is treated with a surface cleaning agent instead of an iron elution accelerator, and a carbon steel test specimen whose surface is treated with an iron elution accelerator;

FIG. 8 is a flowchart showing a procedure of a method for adhering noble metal to a carbon steel member of a nuclear power plant of Example 2, which is another suitable embodiment of the present invention and applied to a cleanup system pipe of a boiling-water nuclear power plant;

FIG. 9 is a detailed configuration diagram of a film-forming apparatus connected to a cleanup system pipe (carbon steel member) of a nuclear power plant in order to perform the method for adhering noble metal shown in FIG. 8;

FIG. 10 is a detailed configuration diagram of a film-forming apparatus which is another example of the film-forming apparatus shown in FIG. 9;

FIG. 11 is a flowchart showing a procedure of a method for preventing the adhesion of radionuclides to a carbon steel member of a nuclear power plant of Example 3, which is another suitable embodiment of the present invention and applied to a cleanup system pipe of a boiling-water nuclear power plant;

FIG. 12 is an explanatory diagram showing a state in which a nickel metal film formed on the inner surface of the cleanup system pipe and having platinum adhered thereto is brought into contact with reactor water containing oxygen at a temperature in the temperature range of 130° C. or higher and 280° C. or less in the method for preventing the adhesion of radionuclides to a carbon steel member of a nuclear power plant shown in FIG. 11;

FIG. 13 is an explanatory diagram showing a state in which oxygen contained in the reactor water at a temperature in the temperature range of 130° C. or higher and 280° C. or lower, and Fez′ in the cleanup system pipe are transferred to the nickel metal film formed on the inner surface of the cleanup system pipe and having platinum adhered thereto, in the method for preventing the adhesion of radionuclides to a carbon steel member of a nuclear power plant shown in FIG. 11;

FIG. 14 is an explanatory diagram showing a state in which a nickel metal film formed on the inner surface of the cleanup system pipe and having platinum adhered thereto is converted into a stable nickel ferrite film, in the method for preventing the adhesion of radionuclides to a carbon steel member of a nuclear power plant shown in FIG. 11; and

FIG. 15 is a flowchart showing a procedure of a method for preventing the adhesion of radionuclides to a carbon steel member of a nuclear power plant of Example 4, which is another suitable embodiment of the present invention and applied to a cleanup system pipe of a boiling-water nuclear power plant.

### DESCRIPTION OF EMBODIMENTS

One method of shortening the time required for forming a nickel metal film on the surface of a carbon steel member by promoting the substitution reaction between iron contained in the carbon steel member of the boiling-water nuclear power plant and nickel contained in the film-forming liquid that contacts the surface of the carbon steel member is proposed in Japanese Patent Application No. 2019-19704 (Filing date: Feb. 6, 2019). In the method for adhering noble metal to a carbon steel member of a nuclear power plant described in Japanese Patent Application No. 2019-19704, after the stop of the operation of a boiling-water nuclear power plant and before the start of the boiling-water nuclear power plant, a film-forming aqueous solution containing nickel ions and a surface cleaning agent (for example, formic acid) and having a pH in the range of 1.8 or more and 2.5 or less is brought into contact with the inner surface of a carbon steel member (for example, cleanup system pipe) of a boiling-water nuclear power plant that contacts reactor water to form a nickel metal film on the inner surface thereof, and noble metal (for example, platinum) adheres to the surface of the formed nickel metal film.

According to the method for adhering noble metal described in Japanese Patent Application No. 2019-19704, since the elution of iron (II) ions from the carbon steel member to the film-forming aqueous solution increases due to the action of the surface cleaning agent and the amount of electrons generated increases as the elution of iron (II) ions increases, the substitution reaction between the iron (II) ions and the nickel ions contained in the film-forming aqueous solution is promoted, and the amount of nickel ions incorporated into the surface of the carbon steel member increases. Since the nickel ions incorporated into the surface of the carbon steel member are reduced by the above-mentioned electrons to become nickel metal, the formation of a nickel metal film on the surface of the carbon steel member is promoted and the time required for forming the nickel metal film is remarkably shortened. In Japanese Patent Application No. 2019-19704, a reducing agent that converts nickel ions into nickel metal is not used.

The inventors conducted various studies on whether or not the time required for forming a nickel metal film in the method for adhering noble metal described in Japanese Patent Application No. 2019-19704 could be further shortened. As a result, the inventors have found a clue to further reduce the time required for forming a nickel metal film. In the method for adhering noble metal described in Japanese Patent Application No. 2019-19704, a surface cleaning agent such as formic acid is injected into the film-forming aqueous solution to increase the elution of iron (II) ions from the carbon steel member to the film-forming aqueous solution and the generation of electrons. By injecting formic acid, the formic acid concentration in the film-forming aqueous solution becomes, for example, 30000 ppm. As described above, in the method for adhering noble metal described in Japanese Patent Application No. 2019-19704, since the concentration of formic acid injected into the film-forming aqueous solution is high, a longer time is required for the decomposition of formic acid contained in the film-forming aqueous solution, which is performed after the formation of the nickel metal film on the surface of the carbon steel member is completed.

Therefore, the inventors devised that the time required for the decomposition of formic acid, which is performed after the formation of the nickel metal film is completed, could be shortened by reducing the amount of formic acid injected into the film-forming aqueous solution and lowering the formic acid concentration in the film-forming aqueous solution. However, when the amount of formic acid injected into the film-forming aqueous solution is small and the formic acid concentration in the film-forming aqueous solution is low, the amount of iron (II) ions eluted from the carbon steel member into the film-forming aqueous solution is small and the amount of generated electrons also decreases. Therefore, the inventors conducted various studies on measures that can alleviate the decrease in the amount of the iron (II) ions eluted from the carbon steel member due to the decrease in the formic acid concentration in the film-forming aqueous solution, resulting in an increase in the amount of iron (II) ions eluted. As a result of these studies, the obtained measures were the use of the Fenton reaction.

The Fenton reaction is a reaction that uses iron as a catalyst to generate hydroxyl radicals having strong oxidizing power from hydrogen peroxide. Hydroxyl radicals contained in the film-forming aqueous solution generated by the Fenton reaction can increase the amount of iron (II) ions eluted from the carbon steel member and it is possible to increase the amount of iron (II) ions eluted from the carbon steel member, which is reduced due to the low concentration of formic acid contained in the film-forming aqueous solution (for example, 1/10 of the formic acid concentration of 30000 ppm in the method for adhering noble metal of Japanese Patent Application No. 2019-19704). The generation of hydroxyl radicals from hydrogen peroxide is brought about by the catalytic action of iron (II) ions eluted from the carbon steel member into the film-forming aqueous solution by the action of formic acid. After the hydroxyl radicals are generated, the iron (II) ions eluted from the carbon steel member into the film-forming aqueous solution by the hydroxyl radicals also have the above-mentioned catalytic action of generating hydroxyl radicals from hydrogen peroxide. In particular, in order to first generate hydroxyl radicals from hydrogen peroxide by the Fenton reaction in the film-forming aqueous solution, the film-forming aqueous solution needs to contain a substance that elutes iron (II) ions from the carbon steel member, such as formic acid.

By conducting various studies, the inventors have come to the idea that it is necessary to inject an iron elution accelerator containing hydrogen peroxide and a small amount of formic acid into a film-forming aqueous solution containing nickel ions in order to increase the amount of the iron (II) ions eluted from the carbon steel member by utilizing the hydroxyl radicals generated by the Fenton reaction. By contacting the surface of the carbon steel member with the film-forming aqueous solution containing nickel ions and an iron elution accelerator, a nickel metal film is formed on the surface of the carbon steel member that contacts the film-forming aqueous solution.

Therefore, the inventors performed the following experiments in order to confirm the formation of a nickel metal film on the surface of the carbon steel member by the contact of the film-forming aqueous solution injected with the iron elution accelerator containing hydrogen peroxide and formic acid with the surface of the carbon steel member. The experiment of forming a nickel metal film on the surface of the carbon steel member was performed under three different experimental conditions, and in each experiment, the formation time of the nickel metal film on the surface of the carbon steel member was checked. In each experiment, a test specimen made of carbon steel (carbon steel test specimen) was used.

In a first experiment, as described in JP-A-2018-48831, a film-forming aqueous solution containing nickel ions and a reducing agent (for example, hydrazine) was brought into contact with the surface of a carbon steel test specimen (hereinafter referred to as test specimen A) to form a nickel metal film on the surface of the test specimen A. In the experiment, the film-forming aqueous solution containing nickel ions and a reducing agent (for example, hydrazine) was filled in a container and the test specimen A was immersed in the film-forming aqueous solution in the container. Nickel ions were supplied into the container as an aqueous solution of nickel formate. Specifically, the test specimen A was immersed in 1 L (liter) of a film-forming aqueous solution having a nickel concentration of 400 ppm and a formic acid concentration of 800 ppm at 90° C. for 4 hours. When 4 hours had passed, the test specimen A having a nickel metal film formed on the surface thereof was taken out from the film-forming aqueous solution.

Ina second experiment, as described in the specification of above-mentioned Japanese Patent Application No. 2019-19704, a film-forming aqueous solution, which had been generated by contacting a surface cleaning agent aqueous solution containing a surface cleaning agent (for example, formic acid) with the surface of a carbon steel test specimen (hereinafter referred to as test specimen B), and then injecting a nickel formate aqueous solution into the surface cleaning agent aqueous solution, was brought into contact with the surface of the test specimen B that had contacted the surface cleaning agent aqueous solution to form a nickel metal film on the surface of the test specimen B. In the experiment, the surface cleaning agent aqueous solution is filled in a container, the test specimen B is immersed in the surface cleaning agent aqueous solution in the container, and after a predetermined time elapses, the nickel formate aqueous solution is injected into the surface cleaning agent aqueous solution in the container to generate a film-forming aqueous solution, and the test specimen B is further immersed in the produced film-forming aqueous solution in the container for a predetermined time. Specifically, the test specimen B was immersed in 1 L (liter) of the surface cleaning agent aqueous solution having a formic acid concentration of 30000 ppm at 90° C. for 1 hour, and when that 1 hour has passed, the nickel formate aqueous solution is injected into the surface cleaning agent aqueous solution in the container to produce the film-forming aqueous solution. The injection of the nickel formate aqueous solution into the surface cleaning agent aqueous solution was performed until the nickel concentration reached 400 ppm and the formic acid concentration reached 30800 ppm in the produced film-forming aqueous solution. The test specimen B was immersed in the produced film-forming aqueous solution in the container for 1 hour. When 1 hour had passed, the test specimen B having a nickel metal film formed on the surface thereof was taken out from the film-forming aqueous solution.

In a third experiment, a film-forming aqueous solution, which had been generated by contacting an iron elution accelerator aqueous solution containing an iron elution accelerator (containing, for example, formic acid and hydrogen peroxide) with the surface of a carbon steel test specimen (hereinafter referred to as test specimen C), and then injecting a nickel formate aqueous solution into the iron elution accelerator aqueous solution, was brought into contact with the surface of the test specimen C that had contacted the iron elution accelerator aqueous solution to form a nickel metal film on the surface of the test specimen C. The film-forming aqueous solution contains an iron elution accelerator, that is, formic acid, which is an iron elution agent, and hydrogen peroxide. In the experiment, the iron elution accelerator aqueous solution is filled in a container, the test specimen C is immersed in the iron elution accelerator aqueous solution in the container, and after a predetermined time elapses, the nickel formate aqueous solution is injected into the iron elution accelerator aqueous solution in the container to produce the film-forming aqueous solution, and the test specimen C is further immersed in the produced film-forming aqueous solution in the container for a predetermined time. Specifically, the test specimen C is immersed in 1 L (liter) of the iron elution accelerator aqueous solution having a formic acid concentration of 3000 ppm and a hydrogen peroxide concentration of 1500 ppm at 90° C. for 1 hour, and when that 1 hour has passed, the nickel formate aqueous solution is injected into the iron elution accelerator aqueous solution in the container to produce the film-forming aqueous solution. The injection of the nickel formate aqueous solution into the iron elution accelerator aqueous solution was performed until the nickel concentration reached 400 ppm and the formic acid concentration reached 3800 ppm in the produced film-forming aqueous solution. The test specimen C was immersed in the produced film-forming aqueous solution in the container for 1 hour. When 1 hour had passed, the test specimen C having the nickel metal film formed on the surface thereof was taken out from the film-forming aqueous solution.

The above iron elution accelerator is used to promote the elution of iron (II) ions from a carbon steel member of a nuclear power plant after the completion of chemical decontamination, specifically, reduction decontamination. The iron elution accelerator contains an iron elution agent and hydrogen peroxide, and any of formic acid, malonic acid, and ascorbic acid, which are the organic acids, is used as the iron elution agent.

By contacting the surface of the test specimen C with an iron elution accelerator aqueous solution at 90° C. containing 3000 ppm of formic acid and 1500 ppm of hydrogen peroxide, the amount of iron (II) ions eluted from the test specimen C into the aqueous solution of the iron elution accelerator increases by the action of 3000 ppm of formic acid. 1500 ppm of hydrogen peroxide produces hydroxyl radicals having strong oxidizing power by the Fenton reaction catalyzed by iron (II) ions eluted from the test specimen C. The action of these hydroxyl radicals promotes the elution of iron (II) ions from the test specimen C, further increasing the amount of iron (II) ions eluted into the iron elution accelerator aqueous solution. Specifically, hydroxyl radicals elute iron (II) ions and electrons (e⁻) from the carbon steel test specimen C into the iron elution accelerator aqueous solution. Hydroxyl radicals disappear when iron (II) ions and electrons (e⁻) are eluted from carbon steel into the iron elution accelerator aqueous solution. Therefore, the amount of iron (II) ions eluted from the test specimen C increases remarkably, and the amount of electrons generated increases as the amount of iron (II) ions eluted increases.

Since the amount of iron (II) ions eluted from the test specimen C is increased by the action of 3800 ppm of formic acid and 1500 ppm of hydrogen peroxide contained in the film-forming aqueous solution produced by injecting the nickel formate aqueous solution containing nickel ions and formic acid into the iron elution accelerator aqueous solution, the substitution reaction between the iron (II) ions in the test specimen C and the nickel ions contained in the film-forming aqueous solution is promoted and the amount of nickel ions incorporated into the surface of the test specimen C increases. The nickel ions incorporated into the test specimen C are reduced by the electrons generated by the elution of iron (II) ions to become nickel metal. Therefore, a nickel metal film is formed on the surface of the test specimen C, and eventually, the entire surface of the test specimen C is covered with the nickel metal film. By the action of 3000 ppm of formic acid and 1500 ppm of hydrogen peroxide, the amount of iron (II) ions eluted from the test specimen C increases, and the substitution reaction between iron (II) ions and nickel is promoted. Thus, the time required for the entire surface of the test specimen C to be covered with the nickel metal film is significantly shortened as compared with the test specimen A. The time required for the entire surface of the test specimen C to be covered with the nickel metal film is the same as the time required for the entire surface of the test specimen B to be covered with the nickel metal film.

However, since the formic acid concentration (3800 ppm) in the film-forming aqueous solution that contacts the surface of the test specimen C is lower than the formic acid concentration (30800 ppm) of the film-forming aqueous solution that contacts the surface of the test specimen B, the time required for the decomposition of formic acid contained in the film-forming aqueous solution that contacts the surface of the test specimen C is shorter than the time required for the decomposition of formic acid contained in the film-forming aqueous solution that contacts the surface of the test specimen B. Therefore, the time required for the adhesion work of the noble metal from the start of preparation for the formation of the nickel metal film on the surface of the test specimen C (the start of the contact of the iron elution accelerator aqueous solution with the surface of the test specimen C) to the end of the adhesion of the noble metal to the surface of the formed nickel metal film can be shortened than the time required for the adhesion work of the noble metal from the start of preparation for the formation of the nickel metal film on the surface of the test specimen B (the start of the contact of the surface cleaning agent aqueous solution with the surface of the test specimen B) to the end of the adhesion of the noble metal to the surface of the formed nickel metal film. The noble metal, for example, platinum, is adhered to the surface of the formed nickel metal film.

The reason why the time required for the decomposition of formic acid contained in the film-forming aqueous solution that contacts the surface of the test specimen C is shortened that the time required for the decomposition of formic acid contained in the film-forming aqueous solution that contacts the surface of the test specimen B described in the specification of Japanese Patent Application No. 2019-19704 is because the concentration of formic acid contained in the film-forming aqueous solution that contacts the test specimen C is lower than the concentration of formic acid contained in the film-forming aqueous solution that contacts the test specimen B. Here, the reason why the concentration of formic acid contained in the film-forming aqueous solution that contacts the test specimen C can be made lower than the concentration of formic acid contained in the film-forming aqueous solution that contacts the test specimen B will be described below. As described above, the film-forming aqueous solution that contacts the test specimen C contains an iron elution accelerator, that is, formic acid (iron elution agent) and hydrogen peroxide. When formic acid comes into contact with the test specimen C, iron (II) ions are eluted from the test specimen C into the film-forming aqueous solution and hydroxyl radicals are generated from hydrogen peroxide by the catalytic action of the iron (II) ions. These hydroxyl radicals promote the elution of iron (II) ions from the test specimen C. Due to the action of formic acid and hydroxyl radicals, the amount of iron (II) ions eluted from the test specimen C is significantly higher than the amount eluted from the test specimen B, and the amount of electrons generated with the elution of iron (II) ions also increases significantly. In the case of the test specimen C, iron (II) ions are eluted from the test specimen C not only by formic acid but also by hydroxyl radicals, and thus, the formic acid concentration of the film-forming aqueous solution that contacts the test specimen C can be reduced from the formic acid concentration of the film-forming aqueous solution that contacts the test specimen B. The same can be said for the iron elution accelerator aqueous solution that contacts the test specimen C.

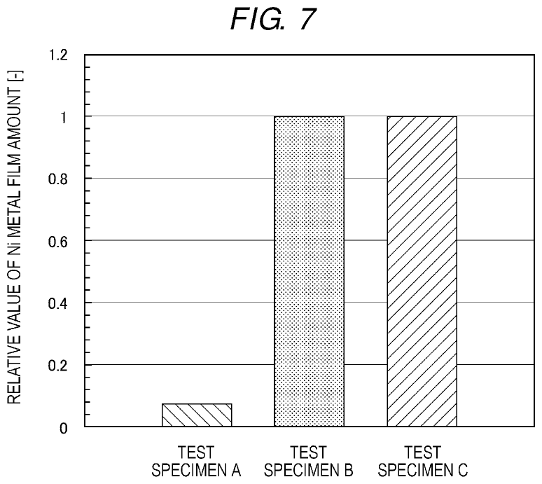

The inventors measured the amount of the nickel metal film formed on the surfaces of the test specimen A, the test specimen B, and the test specimen C. The measurement result is shown in FIG. 7. The amount of the nickel metal film formed on the surfaces of the test specimens B and C is about 12 times the amount of the nickel metal film formed on the surface of the test specimen A. The amount of the nickel metal film formed on the surface of the test specimen C was the same as the amount of the nickel metal film formed on the surface of the test specimen B.

In the concentration of the iron elution agent in the iron elution accelerator aqueous solution, for example, the concentration of formic acid is preferably in the range of 250 ppm to 12000 ppm, and the concentration of hydrogen peroxide is preferably in the range of 150 ppm to 6000 ppm. When the formic acid concentration is 3000 ppm and the hydrogen peroxide concentration is 1500 ppm, the amount of the nickel metal film formed on the surface of the carbon steel member is the largest.

Next, the work for preventing the adhesion of radionuclides to the surface of the carbon steel member, that is, the contact of oxygen-containing water at a temperature in the temperature range of 130° C. or higher and 330° C. or lower to the surface of the nickel metal film to which the noble metal has adhered will be described.

As described in JP-A-2011-32551, when water containing oxygen at 150° C. or higher is brought into contact with a nickel ferrite film containing nickel ferrite having a high iron content, which covers the nickel metal film formed on the surface of a carbon steel member of a BWR plant to convert the nickel metal film into a nickel ferrite film, the nickel ferrite film converted from the nickel metal film becomes an unstable nickel ferrite film (for example, Ni_{0.7}Fe_{2.3}O₄ film). The conversion of the nickel metal film into the unstable nickel ferrite film is because the amount of iron supplied to the nickel metal film increases and the amount of nickel becomes insufficient when the nickel metal film is converted into the nickel ferrite film.

The nickel ferrite film that originally covered the nickel metal film reacts with the nickel metal that had been transferred from the nickel metal film after the contact with high-temperature water to become a Ni_{0.7}Fe_{2.3}O₄ film. The Ni content of the original nickel ferrite film is lower than that of Ni_{0.7}Fe_{2.3}O₄, and the original nickel ferrite film is a nickel ferrite film that is unstable in a reducing environment. The unstable nickel ferrite is a nickel ferrite, for example, Ni_{0.7}Fe_{2.3}O₄, satisfying 0.3≤x<1.0 in Ni₁₋ₓFe₂₊ₓO₄.

Therefore, in JP-A-2011-32551, as in JP-A-2006-38483, the nickel ferrite film is eluted into the reactor water by the adhesion of the noble metal injected during the operation of the BWR plant to the surface of the unstable nickel film. Eventually, at the end of the operation cycle, there is a possibility that the unstable nickel-ferrite film disappears and the carbon steel member is exposed and comes into contact with the reactor water.

Meanwhile, when the noble metal adheres to the surface of the carbon steel member, if Fe²⁺ is eluted from the carbon steel member, the noble metal cannot adhere to the surface of the carbon steel member. In order to prevent the elution of Fe²⁺ from the carbon steel member, to perform the adhesion of the noble metal to the carbon steel member in a short time, and to increase the adhered amount thereof, as described in JP-A-2018-48831, it is preferable to cover the surface of the carbon steel member with a nickel metal film.

In the formation of the nickel metal film on the surface of the carbon steel member during the reduction decontamination agent decomposition process, an aqueous solution (film-forming aqueous solution) that contains nickel ions and oxalic acid and has a pH in the range of 3.5 to 6.0 and a temperature within the range of 60° C. or higher and 100° C. or lower is used. After the reduction decontamination agent decomposition process is completed, for example, in the formation of a nickel metal film on the surface of the carbon steel member after the process of purification of chemical decontamination, an aqueous solution (film-forming aqueous solution) that contains nickel ions and no oxalic acid and has a pH in the range of 3.5 to 6.0 and a temperature within the range of 60° C. or higher and 100° C. or lower is used.

The adhesion of radionuclides to a carbon steel member of the nuclear power plant can be prevented for a longer period of time by forming on the surface of the carbon steel members a stable nickel ferrite film that does not elute even with the adhered noble metal, instead of forming an unstable Ni_{0.7}Fe_{2.3}O₄ film on the surface of the carbon steel members, in the low-temperature range of 60° C. to 100° C. The formation of a stable nickel ferrite film on the surface of the carbon steel member can be realized as follows. By the formation of a high-temperature environment within the temperature range of 130° C. or higher and 330° C. or lower in the carbon steel member and the nickel metal film by contacting oxygen-containing water at a temperature in the temperature range of 130° C. or higher and 330° C. or lower (for example, reactor water) to the nickel metal film formed on the surface of the carbon steel member, and the action of the noble metal adhered on the surface of the nickel metal film, the nickel metal contained in the nickel metal film formed on the surface of the carbon steel member is converted into stable nickel ferrite. The stable nickel ferrite is a nickel ferrite satisfying 0≤x<0.3 in Ni₁₋ₓFe₂₊ₓO₄, and is, for example, a nickel ferrite (NiFe₂O₄) in which x is 0 in Ni₁₋ₓFe₂₊ₓO₄. By applying such condition, the nickel metal film formed on the surface of the carbon steel member becomes a stable nickel ferrite film (for example, nickel ferrite film (NiFe₂O₄ film) in which x is 0 in Ni₁₋ₓFe₂₊ₓO₄) that covers the surface of the carbon steel member and does not elute even by the action of the adhered noble metal.

As the noble metal to adheres to the surface of the nickel metal film formed on the surface of the carbon steel member, any one of platinum, palladium, rhodium, ruthenium, osmium, and iridium may be used. As the reducing agent used when adhering the noble metal to the surface of the carbon steel member, any one of hydrazine derivatives such as hydrazine, formyl hydrazine, hydrazine carboxamide, and carbohydrazide, and hydroxylamine may be used.

The reason why the nickel metal film that is formed on the surface of the carbon steel member and has the noble metal (for example, platinum) adheres thereto is converted into a stable nickel ferrite film (NiFe₂O₄ film) that covers the surface of the carbon steel member by contacting oxygen-containing water having a temperature in the range of 130° C. or higher (preferably, 130° C. or higher and 330° C. or lower) will be described. When water at 130° C. or higher comes into contact with the nickel metal film on the carbon steel member, the nickel metal film and the carbon steel member are heated to 130° C. or higher. Oxygen contained in the water is transferred into the nickel metal film, and Fe contained in the carbon steel member becomes Fe²⁺ and is transferred into the nickel metal film. In a high-temperature environment of 130° C. or higher, for example, due to the action of platinum adhered to the nickel metal film, nickel in the nickel metal film reacts with oxygen and Fe²⁺ transferred into the nickel metal film to produce, for example, a nickel ferrite in which x is 0 in Ni₁₋ₓFe₂₊ₓO₄. Here, the ease of incorporating nickel and iron into the ferrite structure is affected by the noble metal, and when the noble metal is present, nickel is more easily incorporated than iron. Therefore, a stable nickel ferrite (NiFe₂O₄) is produced in which x is 0 in Ni₁₋ₓFe₂₊ₓO₄. The stable nickel ferrite film covers the surface of the carbon steel member.

The nickel ferrite produced as described above, in which x is 0 in Ni₁₋ₓFe₂₊ₓO₄, has large crystal growth, is stable without eluting into the water like a Ni_{0.7}Fe_{2.3}O₄ film even if noble metal adheres, and acts to prevent the adhesion of radionuclides to the carbon steel of the base material. As described above, the stable nickel ferrite film formed by the high-temperature environment of 130° C. or higher and the action of platinum can prevent the adhesion of radionuclides to the carbon steel member for a longer period than the Ni_{0.7}Fe_{2.3}O₄ film formed in the low-temperature range of 60° C. to 100° C.

When the temperature of the oxygen-containing water that comes into contact with the nickel metal film is less than 130° C., the nickel metal film is not converted into a stable nickel ferrite film (NiFe₂O₄ film). In order to convert the nickel metal film into a stable nickel ferrite film that does not elute by the action of the noble metal, the temperature of the water containing oxygen that comes into contact with the nickel metal film needs to be at the temperature within the temperature range of 130° C. or higher (130° C. or higher and 330° C. or lower).

After the formation of the nickel metal film on the surface of the carbon steel member is completed, the aqueous solution containing iron (II) ions, nickel ions, and formic acid (including hydrazine when hydrazine is injected) is removed in a cation exchange resin tower described later and formic acid (or formic acid and hydrazine) is decomposed by a decomposition apparatus described later. After the decomposition of formic acid and hydrazine, the aqueous solution is guided to a mixed bed resin tower described later and impurities contained in the aqueous solution are removed by an ion exchange resin in the mixed bed resin tower to purify the aqueous solution.

Even after purifying the aqueous solution, Fe²⁺ that could not be completely removed by the cation exchange resin tower and the mixed bed resin tower may be present in the aqueous solution. After purification of the aqueous solution, Fe²⁺ existing in the aqueous solution is oxidized by hydrogen peroxide supplied to the aqueous solution to decompose formic acid and the like to become Fe³⁺, which is precipitated as iron hydroxide and magnetite. After that, when noble metal ions and a reducing agent are injected into the aqueous solution in order to adhere the noble metal onto the nickel metal film, a part of the injected noble metal ions adheres as the noble metal to the iron hydroxide and magnetite which have been precipitated by the action of the reducing agent, the amount of the noble metal that adheres to the nickel metal film formed on the surface of the carbon steel member is reduced, and the time required to adhere a predetermined amount of the noble metal to the surface of the nickel metal film becomes long.

Iron ions (Fe³⁺) remaining in the aqueous solution are precipitated as iron hydroxide and magnetite. In order to prevent the noble metal from adhering to iron hydroxide and magnetite, it is known that a complex ion forming agent (for example, ammonia), noble metal ions (for example, platinum ions), and a reducing agent (for example, hydrazine) are injected into the aqueous solution, and the iron ions remaining in the aqueous solution and the injected complex ion forming agent, for example, ammonia, form iron-ammonia complex ions, which prevents the iron ions from being precipitated (see JP-A-2015-158486). The iron ions and ammonia generate iron-ammonia complex ions by each reaction represented by the formulas (4) to (6) described in JP-A-2015-158486.

As such, when iron-ammonia complex ions are generated in the aqueous solution, precipitation of iron ions is prevented in the aqueous solution even if hydrazine is injected and the pH of the aqueous solution becomes alkaline of about 8 or more. By injecting the complex ion forming agent into the aqueous solution, the noble metal ions contained in the aqueous solution can efficiently adhere to the surface of the nickel metal film formed on the surface of the carbon steel members of the plant by the reducing action of hydrazine. Therefore, the time required for the adhesion of the noble metal to the surface of the carbon steel members can be further shortened.

The complex ion forming agent is only required to be a substance that can increase the solubility of Fe³⁺ by forming complex ions and prevent the precipitation of iron hydroxide and magnetite even when the pH of the aqueous solution is increased by injecting a reducing agent (for example, hydrazine), and at least one of monoamines such as ammonia and hydroxylamine, cyanide compounds, urea, and thiocyanate compounds is used.

Preferable examples of the method for adhering noble metal to a carbon steel member of a nuclear power plant and the method for preventing the adhesion of radionuclides to a carbon steel member of a nuclear power plant, which reflect the results of studies on shortening the time required for the work of adhering noble metal to carbon steel members will be described below.

### Example 1

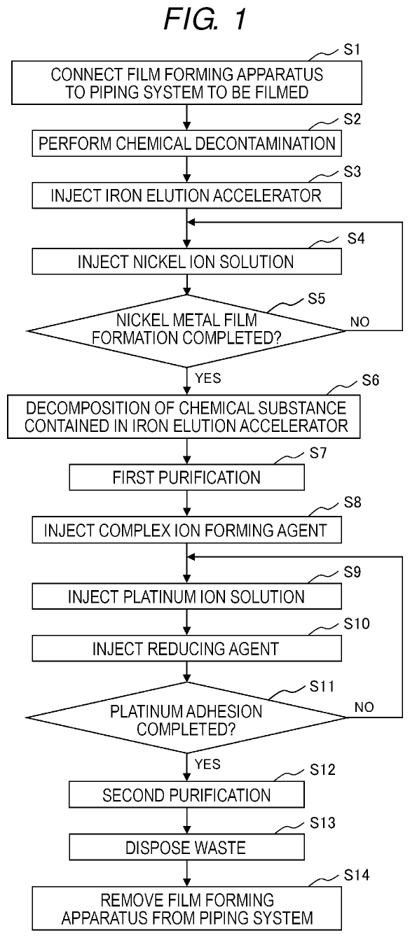

The method for adhering noble metal to a carbon steel member of a nuclear power plant of Example 1, which is a preferred embodiment of the present invention, will be described with reference to FIGS. 1, 2, and 3. The method for preventing the adhesion of radionuclides to a carbon steel member of a nuclear power plant of the example is applied to a carbon steel cleanup system pipe (carbon steel member) of a boiling-water nuclear power plant (BWR plant).

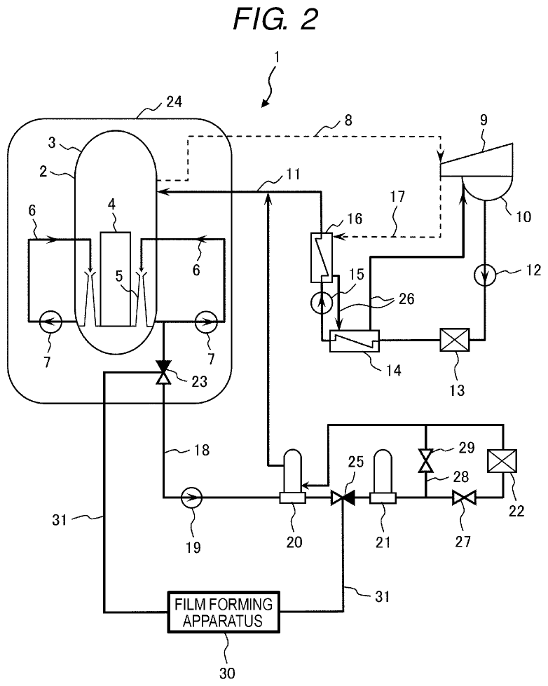

The schematic configuration of the BWR plant will be described with reference to FIG. 2. The BWR plant 1 includes a reactor 2, a turbine 9, a condenser 10, a recirculation system, a reactor cleanup system, a feedwater system, and the like. The reactor 2 is a steam generator, includes a reactor pressure vessel (hereinafter referred to as RPV) 3 including a built-in core 4, and is installed with a plurality of jet pumps 5 in an annular downcomer formed between an outer surface of a core shroud (not shown) surrounding the core 4 in the RPV 3 and the inner surface of the RPV 3. A large number of fuel assemblies (not shown) are loaded in the core 4. The fuel assembly includes a plurality of fuel rods filled with a plurality of fuel pellets made of nuclear fuel material.

The recirculation system includes a stainless steel recirculation system pipe 6 and a recirculation pump 7 installed in the recirculation system pipe 6. In the feedwater system, a condensate pump 12, a condensate polisher (for example, a condensate demineralizer) 13, a low-pressure feedwater heater 14, a feedwater pump 15, and a high-pressure feedwater heater 16 are installed in a feedwater pipe 11 connecting the condenser 10 and the RPV 3 in this order from the condenser 10 toward the RPV 3. In the reactor cleanup system, a cleanup system pump 19, a regenerative heat exchanger 20, a non-regenerative heat exchanger 21, and a reactor water cleanup apparatus 22 are installed in a cleanup system pipe 18 connecting the recirculation system pipe 6 and the feedwater pipe 11 in this order. A bypass pipe 28 including a valve 29 and bypassing the reactor water cleanup apparatus 22 is connected to the cleanup system pipe 18 on the upstream side and the downstream side of the reactor water cleanup apparatus 22. A valve 27 is provided in the cleanup system pipe 18 on the reactor water cleanup apparatus 22 side of the connection point between the bypass pipe 28 and the cleanup system pipe 18. The cleanup system pipe 18 is connected to the recirculation system pipe 6 in the upstream of the recirculation pump 7. The reactor 2 is installed in a primary containment vessel 24 arranged in the reactor building (not shown).

The cooling water in the RPV 3 (hereinafter referred to as reactor water) is boosted by the recirculation pump 7 and jetted into the jet pump 5 through the recirculation system pipe 6. The reactor water existing around the nozzle of the jet pump 5 in the downcomer is also sucked into the jet pump 5 and fed into the core 4 together with the above-mentioned reactor water jetted into the jet pump 5. The reactor water fed into the core 4 is heated by the heat generated by the fission of the nuclear fuel material in the fuel rods in the fuel assembly, and a part thereof becomes steam. The steam is guided from the RPV 3 to the turbine 9 through the main steam pipe 8 to rotate the turbine 9. A generator (not shown) connected to the turbine 9 rotates to generate electric power. The steam discharged from the turbine 9 is condensed by the condenser 10 to become water. The water is fed into the RPV 3 as feedwater through the feedwater pipe 11. The feedwater flowing through the feedwater pipe 11 is boosted by the condensate pump 12, impurities are removed by the condensate polisher 13, and the pressure is further boosted by the feedwater pump 15. The feedwater is heated by the extracted steam extracted from the turbine 9 by an extraction steam pipe 17 in the low-pressure feedwater heater 14 and the high-pressure feedwater heater 16 and is guided into the RPV 3. A drain water recovery pipe 26 connected to the high-pressure feedwater heater 16 and the low-pressure feedwater heater 14 is connected to the condenser 10.

Apart of the reactor water flowing in the recirculation system pipe 6 flows into the cleanup system pipe 18 by driving the cleanup system pump 19, is cooled by the regenerative heat exchanger 20 and the non-regenerative heat exchanger 21, and then is purified in the reactor water cleanup apparatus 22. The purified reactor water is heated by the regenerative heat exchanger 20 and returned to the RPV 3 via the cleanup system pipe 18 and the feedwater pipe 11.

In the method for adhering noble metal to a carbon steel member of a nuclear power plant of the example, a film-forming apparatus 30 is used and the film-forming apparatus 30 is connected to the cleanup system pipe 18 as shown in FIG. 2.

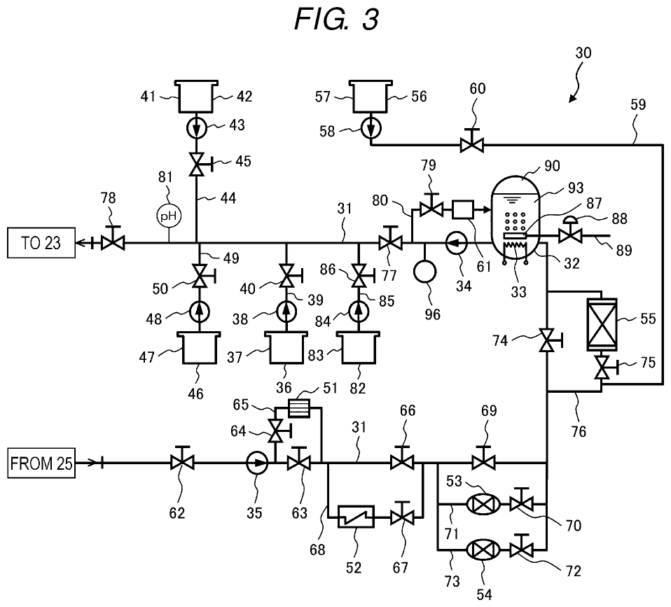

The detailed configuration of the film-forming apparatus 30 will be described with reference to FIG. 3.

The film-forming apparatus 30 includes a circulation pipe 31, a surge tank 32, a heater 33, circulation pumps 34 and 35, a nickel ion injection device 36, a reducing agent injection device 41, a platinum ion injection device 46, a cooler 52, and a cation exchange resin tower 53, a mixed bed resin tower 54, a decomposition device 55, an oxidizing agent supply device 56, an ejector 61, and a formic acid injection device 82 are provided.

An on-off valve 62, the circulation pump 35, valves 63, 66, 69, and 74, the surge tank 32, the circulation pump 34, a valve 77, and an on-off valve 78 are provided in the circulation pipe 31 in this order from the upstream. A pipe 65 that bypasses the valve 63 is connected to the circulation pipe 31 and the valve 64 and a filter 51 are installed in the pipe 65. The cooler 52 and a valve 67 are installed in a pipe 68 whose both ends are connected to the circulation pipe 31 by bypassing the valve 66. The cation exchange resin tower 53 and a valve 70 are installed in a pipe 71 having both ends connected to the circulation pipe 31 and bypassing the valve 69. The mixed bed resin tower 54 and a valve 72 are installed in a pipe 73 having both ends connected to the pipe 71 and bypassing the cation exchange resin tower 53 and the valve 70. The cation exchange resin tower 53 is filled with a cation exchange resin and the mixed bed resin tower 54 is filled with a cation exchange resin and an anion exchange resin.

A pipe 76 in which a valve 75 and the decomposition device 55 located downstream of the valve 75 are installed is connected to the circulation pipe 31 by bypassing the valve 74. The decomposition device 55 is filled with, for example, an activated carbon catalyst in which ruthenium adheres to the surface of the activated carbon. The surge tank 32 is installed in the circulation pipe 31 between the valve 74 and the circulation pump 34. The heater 33 is arranged in the surge tank 32. A space 90 is formed in the surge tank 32 above the liquid level of a film-forming aqueous solution 93 in the surge tank 32. One end of a gas supply pipe 89 provided with a flow rate control valve 88 and penetrating the side wall of the surge tank 32 is connected to an air diffuser pipe 87 arranged in the surge tank 32. The other end of the gas supply pipe 89 is connected to an inert gas cylinder (not shown) filled with inert gas, for example, nitrogen gas. The gas supply pipe 89 and the inert gas cylinder constitute an inert gas supply device.

A pipe 80 provided with a valve 79 and the ejector 61 is connected to the circulation pipe 31 between the valve 77 and the circulation pump 34 and further connected to the surge tank 32. The ejector 61 is provided with a hopper (not shown) for supplying the surge tank 32 with oxalic acid (reduction decontamination agent) used for reducing and dissolving contaminants on the inner surface of the cleanup system pipe 18.

The nickel ion injection device 36 includes a chemical liquid tank 37, an injection pump 38, and an injection pipe 39. The chemical liquid tank 37 is connected to the circulation pipe 31 by the injection pipe 39 provided with the injection pump 38 and a valve 40. For example, a nickel formate aqueous solution (an aqueous solution containing nickel ions) prepared by dissolving nickel formate (Ni(HCOO)₂.2H₂O) in a dilute formic acid aqueous solution is filled in the chemical liquid tank 37.

The platinum ion injection device (noble metal ion injection device) 46 includes a chemical liquid tank 47, an injection pump 48, and an injection pipe 49. The chemical liquid tank 47 is connected to the circulation pipe 31 by the injection pipe 49 provided with the injection pump 48 and a valve 50. An aqueous solution containing platinum ions (for example, sodium hexahydroxy platinate hydrate aqueous solution) prepared by dissolving a platinum complex (for example, sodium hexahydroxy platinate hydrate (Na₂[Pt(OH)₆].nH₂O)) in water and being adjusted is filled in the chemical liquid tank 47. The aqueous solution containing platinum ions is a type of aqueous solutions containing noble metal ions.

The reducing agent injection device 41 includes a chemical liquid tank 42, an injection pump 43, and an injection pipe 44. The chemical liquid tank 42 is connected to the circulation pipe 31 by the injection pipe 44 provided with the injection pump 43 and a valve 45. An aqueous solution of hydrazine, which is a reducing agent, is filled in the chemical liquid tank 42.

The formic acid injection device 82 includes a chemical liquid tank 83, an injection pump 84, and an injection pipe 85. The chemical liquid tank 83 is connected to the circulation pipe 31 by the injection pipe 85 including the injection pump 84 and a valve 86. An aqueous solution of formic acid, which is one chemical substance contained in the iron elution accelerator, is filled in the chemical liquid tank 83. As will be described later, the formic acid concentration in the formic acid aqueous solution in the chemical liquid tank 83 is adjusted to a necessary concentration to make the formic acid concentration in the iron elution accelerator aqueous solution flowing in the cleanup system pipe 18 to 3000 ppm.

The injection pipes 85, 39, 49, and 44 are connected to the circulation pipe 31 between the valve 77 and the on-off valve 78 in that order from the valve 77 toward the on-off valve 78.

The oxidizing agent supply device 56 includes a chemical liquid tank 57, a supply pump 58, and a supply pipe 59. The chemical liquid tank 57 is connected to the pipe 76 upstream of the valve 75 by the supply pipe 59 provided with the supply pump 58 and the valve 60. Hydrogen peroxide, which is an oxidizing agent, is filled in the chemical liquid tank 57. The hydrogen peroxide is used as another chemical substance contained in the iron elution accelerator and as a chemical substance used when decomposing formic acid, oxalic acid, and a reducing agent (for example, hydrazine) in the decomposition device 55.

A pH meter 81 is attached to the circulation pipe 31 between the connection point between the injection pipe 44 and the circulation pipe 31, and the on-off valve 78, and an oxygen concentration meter 96 is attached to the circulation pipe 31 between the circulation pump 34 and the valve 77.

The BWR plant 1 is stopped after the operation in one operation cycle is completed. After the stop of the operation, a part of the fuel assemblies loaded in the core 4 is taken out as used fuel assemblies, and new fuel assemblies having a burnup of 0 GWd/t are loaded in the core 4. After such refueling is completed, the BWR plant 1 is restarted for the operation in the next operation cycle. Maintenance and inspection of the BWR plant 1 are performed using the period during which the BWR plant 1 is stopped for refueling.

During the period when the operation of the BWR plant 1 is stopped as described above, the method for adhering noble metal to a carbon steel member of a nuclear power plant of the example is performed on the carbon steel piping system connected to the RPV 3, which is one of the carbon steel members in the BWR plant 1, for example, the cleanup system pipe 18. In the method for adhering noble metal, the oxide film incorporating radionuclides formed on the inner surface of the cleanup system pipe 18 that contacts the reactor water is removed by chemical decontamination, and then a process of adhering nickel metal to the inner surface of the cleanup system pipe 18, and a process of adhering noble metal, for example, platinum to the adhered nickel metal are performed.

The method for adhering noble metal to a carbon steel member of a nuclear power plant of the example will be described below based on the procedure shown in FIG. 1. In the method of adhering noble metal to a carbon steel member of a nuclear power plant of the example, the film-forming apparatus 30 is used and each process of steps S1 to S14 shown in FIG. 1 is performed.

First, the film-forming apparatus is connected to the carbon steel piping system to be filmed (step S1). When the operation of the BWR plant 1 is stopped, for example, the bonnet of a valve 23 installed in the cleanup system pipe 18 is opened to block the recirculation system pipe 6 side. One end of the circulation pipe 31 of the film-forming apparatus 30 on the on-off valve 78 side is connected to the flange of the valve 23. The bonnet of a valve 25 installed in the cleanup system pipe 18 between the regenerative heat exchanger 20 and the non-regenerative heat exchanger 21 is opened to block the non-regenerative heat exchanger 21 side. The other end of the circulation pipe 31 on the on-off valve 62 side is connected to the flange of the valve 25. Both ends of the circulation pipe 31 are connected to the cleanup system pipe 18 and a closed-loop including the cleanup system pipe 18 and the circulation pipe 31 is formed.

In the example, the film-forming apparatus 30 is connected to the cleanup system pipe 18 of the reactor cleanup system, but in addition to the cleanup system pipe 18, the film-forming apparatus 30 may be connected to any of the carbon steel pipes of a residual heat removal system which is a carbon steel member and connected to the RPV 3, a reactor core isolation cooling system, a core spray system, and feedwater system, and the method for preventing the adhesion of radionuclides to a carbon steel member of a nuclear power plant of the example may be applied to the carbon steel pipe.

Each process of steps S2 to S14 described below is performed by the film-forming apparatus 30 on the portion of the cleanup system pipe 18 between the valve 23 and the valve 25.

Chemical decontamination of the carbon steel piping system to be filmed is performed (step S2). In the BWR plant 1 that has experienced operation in the previous operation cycle, an oxide film containing radionuclides is formed on the inner surface of the cleanup system pipe 18 that contacts the reactor water flowing from the RPV 3. Before forming the nickel metal film on the inner surface of the cleanup system pipe 18, it is preferable to remove the oxide film containing radionuclides from the inner surface of the cleanup system pipe 18 in order to reduce the dose rate. The removal of the oxide film improves the adhesion between the nickel metal film and the inner surface of the cleanup system pipe 18. In order to remove the oxide film, chemical decontamination, particularly reduction decontamination using a reduction decontamination solution containing oxalic acid as a reduction decontamination agent, is performed on the inner surface of the cleanup system pipe 18.

The chemical decontamination applied to the inner surface of the cleanup system pipe 18 in step S2 is the known reduction decontamination described in JP-A-2000-105295. The reduction decontamination will be described.

First, the on-off valve 62, the valves 63, 66, 69, 74, and 77, and the on-off valve 78 are opened, respectively, and the circulation pumps 34 and 35 are driven with the other valves closed. As a result, the water heated to 90° C. by the heater 33 in the surge tank 32 circulates in the closed-loop formed by the circulation pipe 31 and the cleanup system pipe 18. When the temperature of the water reaches 90° C., the valve 79 is opened to guide a part of the water flowing in the circulation pipe 31 into the pipe 80. A predetermined amount of oxalic acid supplied from the hopper and the ejector 61 into the pipe 80 is guided into the surge tank 32 by the water flowing in the pipe 80. The oxalic acid dissolves in the water in the surge tank 32 and an aqueous oxalic acid solution (reduction decontamination solution) is generated in the surge tank 32.

The oxalic acid aqueous solution is discharged from the surge tank 32 to the circulation pipe 31 by driving the circulation pump 34. The hydrazine aqueous solution in the chemical liquid tank 42 of the reducing agent injection device 41 is injected into the oxalic acid aqueous solution in the circulation pipe 31 through the injection pipe 44 by opening the valve 45 and driving the injection pump 43. The injection pump 43 (or the opening degree of the valve 45) is controlled based on the pH value of the oxalic acid aqueous solution measured by the pH meter 81 to adjust the injection amount of the hydrazine aqueous solution into the circulation pipe 31, and the pH of the aqueous oxalic acid solution supplied to the cleanup system pipe 18 is adjusted to 2.5. In the example, hydrazine, which is a reducing agent used when adhering noble metal, for example, platinum to the nickel metal film formed on the inner surface of the cleanup system pipe 18 (the process of step S10 described later), is used as a pH adjuster to adjust the pH of the oxalic acid aqueous solution in the reduction decontamination process.

The aqueous solution of oxalic acid at 90° C. having a pH of 2.5 is supplied from the circulation pipe 31 to the cleanup system pipe 18, and the oxalic acid in the aqueous solution dissolves the radionuclide-containing oxide film formed on the inner surface of the cleanup system pipe 18. The oxalic acid aqueous solution flows through the cleanup system pipe 18 while dissolving the oxide film and is returned to the circulation pipe 31. The oxalic acid aqueous solution circulates in the closed-loop including the circulation pipe 31 and the cleanup system pipe 18, performs reduction decontamination of the inner surface of the cleanup system pipe 18, and dissolves the oxide film formed on the inner surface thereof.

As the oxide film dissolves, the radionuclide concentration and Fe concentration in the oxalic acid aqueous solution increase. In order to prevent the increase in these concentrations, the valve 70 is opened to reduce the opening degree of the valve 69, and a part of the oxalic acid aqueous solution returned to the circulation pipe 31 is guided to the cation exchange resin tower 53 by the pipe 71. Metal cations such as radionuclides and Fe contained in the oxalic acid aqueous solution are adsorbed and removed by the cation exchange resin in the cation exchange resin tower 53. The oxalic acid aqueous solution discharged from the cation exchange resin tower 53 and the oxalic acid aqueous solution passing through the valve 69 are resupplied to the cleanup system pipe 18 from the circulation pipe 31 and used for reduction decontamination of the cleanup system pipe 18.

In the reduction decontamination of the surface of a carbon steel member (for example, cleanup system pipe 18) using oxalic acid, iron (II) oxalate having a low solubility is formed on the surface of the carbon steel member, and the iron (II) oxalate may prevent the dissolution of the oxide film on the surface of the carbon steel member by oxalic acid. Here, the valve 69 is fully opened and the valve 70 is closed to stop the supply of the oxalic acid aqueous solution to the cation exchange resin tower 53. The valve 60 is opened to start the supply pump 58 and the hydrogen peroxide in the chemical liquid tank 57 is supplied to the oxalic acid aqueous solution flowing in the circulation pipe 31 through the supply pipe 59 and the pipe 76 with the valve 75 closed. The oxalic acid aqueous solution containing hydrogen peroxide is guided to the cleanup system pipe 18. Therefore, Fe (II) contained in iron (II) oxalate formed on the inner surface of the cleanup system pipe 18 is oxidized to Fe (III) by the action of the hydrogen peroxide, and the iron (II) oxalate is dissolved in the oxalic acid aqueous solution as iron (III) oxalate complex. That is, iron (II) oxalate, and hydrogen peroxide and oxalic acid contained in the oxalic acid aqueous solution cause the reaction represented by Formula (1) to generate the iron (III) oxalate complex, water, and hydrogen ions.

2Fe(COO)₂+H₂O₂+2(COOH)₂→2Fe[(COO)₂]²⁻+2H₂O+2H⁺ (1)

After it was confirmed that iron (II) oxalate formed on the inner surface of the cleanup system pipe 18 was dissolved and the hydrogen peroxide injected into the aqueous oxalic acid solution disappeared by the reaction of Formula (1), a part of the oxalic acid aqueous solution that has passed through the valve 66 of the circulation pipe 31 is supplied to the cation exchange resin tower 53 through the pipe 71. Metal cations such as radionuclides contained in the oxalic acid aqueous solution are adsorbed and removed by the cation exchange resin in the cation exchange resin tower 53. The disappearance of hydrogen peroxide in the oxalic acid aqueous solution can be confirmed, for example, by immersing a test paper that reacts with hydrogen peroxide in the oxalic acid aqueous solution sampled from the circulation pipe 31 and observing the color appearing on the test paper.

Oxalic acid and hydrazine contained in the oxalic acid aqueous solution are decomposed when the dose rate at the reduction decontamination site of the cleanup system pipe 18 drops to a set dose rate, or when the reduction decontamination time of the cleanup system pipe 18 reaches a predetermined time. That is, the reduction decontamination agent decomposition process is performed. The fact that the dose rate at the reduction decontamination site has dropped to the set dose rate can be confirmed by the dose rate obtained based on the output signal of the radiation detector that detects the radiation from the reduction decontamination site of the cleanup system pipe 18.

The decomposition of oxalic acid and hydrazine is performed as follows. The oxalic acid aqueous solution containing hydrazine, which has partially reduced the opening degree of the valve 74 by opening the valve 75 and passed through the valve 69 and the valve 70, is supplied to the decomposition device 55 by the pipe 76 through the valve 75. Here, by opening the valve 60 and driving the supply pump 58, the hydrogen peroxide in the chemical liquid tank 57 is supplied to the decomposition device 55 through the supply pipe 59 and the pipe 76. The oxalic acid and hydrazine contained in the oxalic acid aqueous solution are decomposed in the decomposition device 55 by the action of the activated carbon catalyst and the supplied hydrogen peroxide. The decomposition reaction of oxalic acid and hydrazine in the decomposition device 55 is represented by Formulas (2) and (3).

(COOH)₂+H₂O₂→2CO₂+2H₂O (2)

N₂H₄+2H₂O₂→N₂+4H₂O (3)

The decomposition of oxalic acid and hydrazine in the decomposition device 55 is performed while circulating the oxalic acid aqueous solution in the closed-loop including the circulation pipe 31 and the cleanup system pipe 18. The amount of hydrogen peroxide supplied from the chemical liquid tank 57 to the decomposition device 55 is adjusted by controlling the rotation speed of the supply pump 58 so that the supplied hydrogen peroxide is completely consumed in the decomposition of oxalic acid and hydrazine in the decomposition device 55 and does not flow out from the decomposition device 55.

Even in the reduction decontamination agent decomposition process, if oxalic acid is present in the oxalic acid aqueous solution, iron (II) oxalate may be formed on the inner surface of the cleanup system pipe 18 that contacts the oxalic acid aqueous solution. Therefore, when the decomposition of oxalic acid and hydrazine contained in the oxalic acid aqueous solution has progressed to some extent, the rotation speed of the supply pump 58 is increased to increase the amount of hydrogen peroxide supplied from the chemical liquid tank 57 to the decomposition device 55 so that hydrogen peroxide flows out from the decomposition device 55. Here, the valve 69 is closed in advance to prevent hydrogen peroxide from flowing into the cation exchange resin tower 53.

The oxalic acid aqueous solution containing hydrogen peroxide discharged from the decomposition device 55 is guided from the circulation pipe 31 to the cleanup system pipe 18. As described above, iron (II) oxalate formed on the inner surface of the cleanup system pipe 18 which is a carbon steel member becomes an iron (III) oxalate complex by the action of hydrogen peroxide and is dissolved in the aqueous oxalic acid solution. Since the decomposition of oxalic acid and the like in the oxalic acid aqueous solution is progressing, the oxalic acid for converting Fe (II) contained in iron (II) oxalate into Fe (III) which is easily dissolved is insufficient and Fe(OH)₃ is likely to be precipitated on the inner surface of the circulation pipe 31. Therefore, in order to prevent the precipitation of Fe(OH)₃, formic acid is injected into the oxalic acid aqueous solution. The injection of formic acid is performed by the formic acid injection device 82. The valve 86 is opened to drive the injection pump 84 and the formic acid aqueous solution is injected from the chemical liquid tank 83 into the circulation pipe 31.

The oxalic acid aqueous solution containing formic acid in the circulation pipe 31 is supplied from the circulation pipe 31 to the cleanup system pipe 18. The aqueous oxalic acid solution containing formic acid contains hydrogen peroxide discharged from the decomposition device 55 in addition to oxalic acid and hydrazine in the reduced concentrations. The hydrogen peroxide contained in the oxalic acid aqueous solution dissolves iron (II) oxalate precipitated on the inner surface of the cleanup system pipe 18 and formic acid dissolves Fe (OH) 3. Since the oxalic acid aqueous solution circulates in the closed-loop including the circulation pipe 31 and the cleanup system pipe 18, the decomposition of oxalic acid and hydrazine is also continued in the decomposition device 55.

Next, in order to end the oxalic acid decomposition process, the opening degree of the valve 60 is reduced to the extent that hydrogen peroxide does not flow out from the decomposition device 55, and the valve 79 is closed to stop the injection of new formic acid. When the injection of hydrogen peroxide and formic acid into the oxalic acid aqueous solution flowing in the circulation pipe 31 is stopped, the concentrations thereof in the oxalic acid aqueous solution also decrease. When the hydrogen peroxide concentration in the oxalic acid aqueous solution becomes 1 ppm or less, the valve 70 is opened to reduce the opening degree of the valve 69, and the oxalic acid aqueous solution is supplied to the cation exchange resin tower 53. As described above, the metal cations contained in the oxalic acid aqueous solution are removed by the cation exchange resin in the cation exchange resin tower 53, and the metal cation concentration in the oxalic acid aqueous solution decreases. The decomposition of oxalic acid, hydrazine, and formic acid is continued in the decomposition device 55. Among oxalic acid, hydrazine, and formic acid, hydrazine is decomposed first, then oxalic acid is decomposed, and formic acid remains last. Here, the decomposition process of oxalic acid is completed.

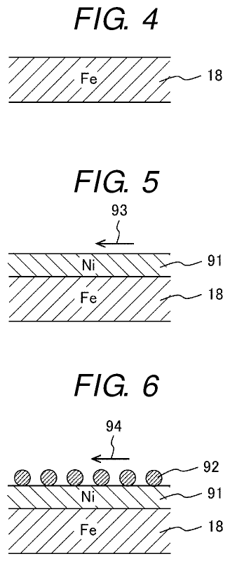

When the chemical decontamination described above is completed, the oxide film containing radionuclides has been removed from the inner surface of the cleanup system pipe 18, the cleanup system pipe 18 is in the state shown in FIG. 4, and the aqueous solution containing the remaining formic acid described above is in contact with the inner surface of the cleanup system pipe 18.

The temperature of the film-forming aqueous solution is adjusted. The valves 69 and 74 are opened and the valves 70 and 75 are closed. Since the circulation pumps 34 and 35 are driven, the aqueous solution containing the remaining formic acid circulates in the closed-loop including the circulation pipe 31 and the cleanup system pipe 18. The aqueous solution containing formic acid is heated to 90° C. by the heater 33. The temperature of the formic acid aqueous solution (film-forming aqueous solution described later) is preferably in the range of 60° C. to 100° C. (60° C. or higher and 100° C. or lower).

The valve 64 is opened and the valve 63 is closed. By these valve operations, the formic acid aqueous solution flowing in the circulation pipe 31 is supplied to the filter 51, and the fine solid content remaining in the formic acid aqueous solution is removed by the filter 51. If the fine solid content is not removed by the filter 51, a nickel metal film is also formed on the surface of the solid material and the injected nickel ions are wastefully consumed when the nickel formate aqueous solution is injected into the circulation pipe 31 when forming the nickel metal film on the inner surface of the cleanup system pipe 18. The supply of the formic acid aqueous solution to the filter 51 is to prevent such wasteful consumption of nickel ions.

An iron elution accelerator is injected (step S3). In the example, an iron elution accelerator containing formic acid and hydrogen peroxide is used, but formic acid and hydrogen peroxide are separately injected into the circulation pipe 31. Then, the iron elution accelerator is substantially produced in the circulation pipe 31 by the injected formic acid and hydrogen peroxide. This corresponds to substantially injecting the iron elution accelerator into the circulation pipe 31.

The valve 63 is opened, the valve 64 is closed, and the flow of water to the filter 51 is stopped. Since the formic acid concentration of the aqueous solution at 90° C. containing the remaining formic acid is extremely low, the valve 86 of the formic acid injection device 82 is opened to start the injection pump 84, and the formic acid aqueous solution at a high concentration in the chemical liquid tank 83 is injected into the circulation pipe 31 through the injection pipe 85. The amount of the formic acid aqueous solution in the chemical liquid tank 83 supplied to the circulation pipe 31 is adjusted by controlling the rotation speed of the injection pump 84 (or the opening degree of the valve 86) so that the formic acid concentration in the aqueous solution at 90° C. flowing in the circulation pipe 31 becomes, for example, 3000 ppm. The valve 60 of the oxidizing agent supply device 56 is opened to start the supply pump 58, and the hydrogen peroxide aqueous solution in the chemical liquid tank 57 is injected into the circulation pipe 31 through the supply pipe 59 and the pipe 76. Here, the valve 75 is closed. The amount of the hydrogen peroxide aqueous solution in the chemical liquid tank 57 supplied to the circulation pipe 31 is adjusted by controlling the rotation speed of the supply pump 58 (or the opening degree of the valve 60) so that the hydrogen peroxide concentration in the aqueous solution at 90° C. flowing in the circulation pipe 31 becomes, for example, 1500 ppm.

It is desirable to inject the formic acid aqueous solution from the formic acid injection device 82 into the circulation pipe 31 when the hydrogen peroxide aqueous solution at 90° C. containing hydrogen peroxide supplied to the circulation pipe 31 through the supply pipe 59 and the pipe 76 flows through the circulation pipe 31 and reaches the connection point between the injection pipe 85 and the circulation pipe 31. An iron elution accelerator containing formic acid and hydrogen peroxide, that is, an iron elution accelerator aqueous solution containing formic acid and hydrogen peroxide is generated in the circulation pipe 31 downstream from the connection point between the injection pipe 85 and the circulation pipe 31. The oxidizing agent supply device 56 that supplies hydrogen peroxide to the circulation pipe 31 to generate the iron elution accelerator aqueous solution functions as a hydrogen peroxide injection device.

The aqueous solution of the iron elution accelerator at 90° C. containing formic acid having a concentration of 3000 ppm and hydrogen peroxide having a concentration of 1500 ppm is supplied from the circulation pipe 31 to the cleanup system pipe 18. The iron elution accelerator aqueous solution circulates in the closed-loop including the cleanup system pipe 18 and the circulation pipe 31 while contacting the inner surface of the cleanup system pipe 18.

Iron (II) ions are eluted from the cleanup system pipe 18 into the iron elution accelerator aqueous solution by the action of 3000 ppm of formic acid contained in the iron elution accelerator. By the catalytic action of iron (II) ions, hydroxyl radicals having strong oxidizing power are generated from 1500 ppm of hydrogen peroxide in the iron elution accelerator aqueous solution. When these hydroxyl radicals act on the inner surface of the cleanup system pipe 18, iron (II) ions are further eluted from the cleanup system pipe 18 into the iron elution accelerator aqueous solution. As such, the elution of iron (II) ions from the cleanup system pipe 18 into the iron elution accelerator aqueous solution is promoted. A large amount of electrons are generated as the elution of iron (II) ions is promoted. The generated electrons are present in the iron elution accelerator aqueous solution. The iron elution accelerator aqueous solution circulating in the closed-loop comes into contact with the inner surface of the cleanup system pipe 18 for 1 hour.

A nickel ion aqueous solution is injected (step S4). When one hour has passed from the start of contact of the iron elution accelerator aqueous solution to the inner surface of the cleanup system pipe 18, the supply pump 58 of the oxidizing agent supply device 56 is stopped, the valve 60 is closed, and the injection of the hydrogen peroxide aqueous solution into the circulation pipe 31 is stopped. The injection pump 84 of the formic acid injection device 82 is stopped, the valve 86 is closed, and the injection of the formic acid aqueous solution into the circulation pipe 31 by the formic acid injection device 82 is also stopped. After that, the valve 40 of the nickel ion injection device 36 is opened to drive the injection pump 38, and the nickel formate aqueous solution in the chemical liquid tank 37 is injected into the iron elution accelerator aqueous solution at 90° C. containing 3000 ppm of formic acid and 1500 ppm of hydrogen peroxide and flowing in the circulation pipe 31 through the injection pipe 39. By injecting the nickel formate aqueous solution into the iron elution accelerator aqueous solution, a film-forming aqueous solution is generated in the circulation pipe 31. The injection amount of the nickel formate aqueous solution and the formic acid concentration in the nickel formate aqueous solution in the chemical liquid tank 37 are adjusted so that the nickel ion concentration in the film-forming aqueous solution produced by the injection of the nickel formate aqueous solution becomes, for example, 400 ppm. The formic acid concentration in the film-forming aqueous solution produced by the injection of the nickel formate aqueous solution is 3800 ppm.

The pH of the produced film-forming aqueous solution is adjusted to be in the range of 2.5 to 4.0 (2.5 or more and 4.0 or less). For example, the pH of the produced film-forming aqueous solution can be adjusted by changing the mixing ratio of nickel formate and formic acid in the chemical liquid tank 37, changing the injection amount of the nickel formate aqueous solution adjusted in the chemical liquid tank 37, and changing the injection amount of formic acid in the chemical liquid tank 83.

The film-forming aqueous solution at 90° C. containing 400 ppm of nickel ions, 3800 ppm of formic acid, and 1500 ppm of hydrogen peroxide and having a pH of 2.5 is supplied from the circulation pipe 31 to the cleanup system pipe 18 by driving the circulation pump 34. When the film-forming aqueous solution 93 comes into contact with the inner surface of the cleanup system pipe 18, a nickel metal film 91 is formed on the inner surface of the cleanup system pipe 18 (see FIG. 5). The formation of the nickel metal film 91 is performed as follows. Before injecting the nickel formate aqueous solution into the iron elution accelerator aqueous solution, the injection of the formic acid aqueous solution and the hydrogen peroxide aqueous solution is stopped as described above, but formic acid and hydrogen peroxide are present in the film-forming aqueous solution 93 produced by the injection of the nickel formate aqueous solution into the iron elution accelerator aqueous solution. When the inner surface of the cleanup system pipe 18 comes into contact with the pH 2.5 film-forming aqueous solution 93, iron (II) ions are eluted from the cleanup system pipe 18 into the film-forming aqueous solution 93 by the action of formic acid contained in the film-forming aqueous solution 93. By the catalytic action of the iron (II) ions, hydroxyl radicals are generated in the film-forming aqueous solution 93 from the hydrogen peroxide present in the film-forming aqueous solution 93. When these hydroxyl radicals act on the inner surface of the cleanup system pipe 18, iron (II) ions are further eluted from the cleanup system pipe 18 into the film-forming aqueous solution 93. The substitution reaction between nickel contained in the film-forming aqueous solution 93 and iron (II) ions in the cleanup system pipe 18 is accelerated, and the amount of nickel ions incorporated into the inner surface of the cleanup system pipe 18 increases. A large amount of electrons are generated with the elution of a large amount of iron (II) ions. The nickel ions incorporated into the inner surface of the cleanup system pipe 18 are reduced by the electrons generated by the elution of iron (II) ions to become nickel metal. The electrons generated in the process of step S3 and present in the iron elution accelerator aqueous solution are also present in the film-forming aqueous solution 93 generated thereafter and contribute to the formation of nickel metal by the reduction of the nickel ions.

While hydrogen peroxide is present in the film-forming aqueous solution 93, hydroxyl radicals are generated from the hydrogen peroxide, and iron (II) ions are eluted from the cleanup system pipe 18 by the hydroxyl radicals. The hydrogen peroxide remaining in the film-forming aqueous solution is decomposed by the generation of hydroxyl radicals, and eventually, hydrogen peroxide does not exist in the film-forming aqueous solution. On the other hand, the injected formic acid remains in the film-forming aqueous solution until it is decomposed in the process of step S6 described later. Even after the injection of the formic acid aqueous solution is stopped, iron (II) ions are eluted from the cleanup system pipe 18 by the action of formic acid existing in the film-forming aqueous solution, and electrons are generated. Nickel ions incorporated into the inner surface of the cleanup system pipe 18 by the substitution reaction are also reduced to nickel metal by these electrons.

The film-forming aqueous solution 93 discharged from the cleanup system pipe 18 to the circulation pipe 31 is supplied to the cleanup system pipe 18 again after the nickel formate aqueous solution is injected from the nickel ion injection device 36. As such, the film-forming aqueous solution 93 is circulated in the closed-loop including the circulation pipe 31 and the cleanup system pipe 18, and eventually, the nickel metal film 91 uniformly covers the entire inner surface of the cleanup system pipe 18 that contacts the film-forming aqueous solution 93. Here, the nickel metal film 91 existing on the inner surface of the cleanup system pipe 18 contains, for example, nickel metal in the range of 500 μg or more and 4000 μg or less per square centimeter (500 to 4000 μg/cm²).

In the process of step S3, which is a process before the process of step S4, the iron elution accelerator aqueous solution is brought into contact with the inner surface of the cleanup system pipe 18 to remove impurities (for example, iron hydroxide) existing on the inner surface of the cleanup system pipe 18 after the chemical decontamination (step S2) is completed. When the film-forming aqueous solution 93 is brought into contact with the inner surface of the cleanup system pipe 18 while the impurities remain on the inner surface of the cleanup system pipe 18, the impurities remain between the inner surface of the cleanup system pipe 18 and the nickel metal film 91 formed on the inner surface thereof, which may hinder the adhesion between the nickel metal film 91 and the cleanup system pipe 18. Due to impurities remaining on the inner surface of the cleanup system pipe 18, the elution of iron (II) ions from the cleanup system pipe 18 by formic acid and hydroxyl radicals contained in the iron elution accelerator aqueous solution in a state where the iron elution accelerator aqueous solution is in contact with the inner surface of the cleanup system pipe 18 is also inhibited.

By performing the process of step S3 before the process of step S4, impurities remaining on the inner surface of the cleanup system pipe 18 can be removed by the action of formic acid and hydroxyl radicals contained in the iron elution accelerator aqueous solution that contacts the inner surface of the cleanup system pipe 18, the adhesion between the nickel metal film 91 and the cleanup system pipe 18 can be enhanced, and the elution of iron (II) ions from the cleanup system pipe 18 is promoted.

It is determined whether the formation of the nickel metal film is completed (step S5). If the nickel metal film 91 formed on the inner surface of the cleanup system pipe 18 is insufficient, the processes of steps S4 and S5 are repeated. When the elapsed time from the injection of the nickel formate aqueous solution into the circulation pipe 31 reaches a set time (for example, 1 hour), the determination result in step S5 becomes “YES”, the injection pumps 38 and 84 are stopped, the valves 40 and 86 are closed, and the injection of the nickel formate aqueous solution and formic acid from the chemical liquid tanks 37 and 87 into the circulation pipe 31 is stopped. As a result, the formation of the nickel metal film 91 on the inner surface of the cleanup system pipe 18 is completed.

The nickel metal film 91 having a set thickness contains, for example, nickel metal in the range of 500 μg/cm² to 4000 μg/cm² (500 μg/cm² or more and 4000 μg/cm² or less) on the inner surface of the cleanup system pipe 18. When the determination result in step S5 in the example is “YES”, the nickel metal film 91 formed on the inner surface of the cleanup system pipe 18 contains, for example, 2000 μg/cm² of nickel metal.

The chemical substances contained in the iron elution accelerator are decomposed (step S6). Hydrogen peroxide, which is one of the chemical substances, among the iron elution accelerators is decomposed when the nickel metal film is formed, and thus, hydrogen peroxide is hardly contained in the film-forming aqueous solution flowing through the circulation pipe 31. The opening degree of the valve 69 is narrowed down to open the valve 70, and a part of the film-forming aqueous solution 93 containing nickel ions and formic acid is guided to the cation exchange resin tower 53 through the pipe 71. Nickel ions contained in a part of the film-forming aqueous solution 93 are adsorbed and removed by the cation exchange resin in the cation exchange resin tower 53. By opening the valve 75 and closing a part of the opening degree of the valve 74, the film-forming aqueous solution 93 containing formic acid discharged from the cation exchange resin tower 53 and the film-forming aqueous solution 93 containing nickel ions and formic acid that have passed through the valve 69 are guided to the decomposition device 55 through the pipe 76. Here, hydrogen peroxide in the chemical liquid tank 57 is supplied to the decomposition device 55 through the supply pipe 59 and the pipe 76. Formic acid (other chemical substances) contained in the film-forming aqueous solution 93 is decomposed into carbon dioxide and water by the action of the activated carbon catalyst and hydrogen peroxide in the decomposition device 55.

The film-forming aqueous solution in which formic acid has been decomposed is purified (step S7). After the formic acid was decomposed, the valve 74 is opened and the valve 75 is closed to stop the supply of the film-forming aqueous solution 93 in which the formic acid concentration has been reduced to the decomposition device 55, the valve 67 is opened and the valve 66 is closed, the valve 72 is opened, and a part of the opening degree of the valve 69 is closed. Here, the valve 70 is closed and the circulation pumps 35 and 34 are being driven. The film-forming aqueous solution 93 having a reduced formic acid concentration, which has been returned from the cleanup system pipe 18 to the circulation pipe 31, is cooled by the cooler 52 until it reaches 60° C. The film-forming aqueous solution 93 at 60° C. having a reduced formic acid concentration is guided to the mixed bed resin tower 54, and nickel ions, other cations, and anions remaining in the film-forming aqueous solution 93 are adsorbed and removed by the cation exchange resin and the anion exchange resin in the mixed bed resin tower 54 (first purification process). The film-forming aqueous solution at 60° C. having a reduced formic acid concentration is circulated in the circulation pipe 31 and the cleanup system pipe 18 until each of the above ions is substantially eliminated. The film-forming aqueous solution in which each ion is substantially eliminated is substantially water at 60° C.

The aqueous solution of the complex ion forming agent is injected (step S8). After the first purification process is completed, the valve 69 is opened, the valve 72 is closed, the valve 79 is opened, water is passed through the ejector 61, and the aqueous ammonia solution, which is a complex ion forming agent aqueous solution, is sucked from the hopper by the ejector 61. The aqueous ammonia solution is supplied to the water at 60° C. containing a trace amount of Fe³⁺ in the surge tank 32. The aqueous solution at 60° C. containing a trace amount of Fe³⁺ and ammonia is boosted by the circulation pump 34 from the surge tank 32 and supplied to the cleanup system pipe 18 by the circulation pipe 31. The aqueous solution at 60° C. containing ammonia reaches the circulation pump 35 along the formed closed loop, is boosted by the circulation pump 35, and is returned to the surge tank 32.

The platinum ion aqueous solution is injected (step S9). The aqueous solution at 60° C. containing ammonia flowing in the circulation pipe 31 is maintained at 60° C. by heating with the heater 33. After the ammonia injection is completed, the valve 50 is opened to drive the injection pump 48. The aqueous solution containing platinum ions (for example, an aqueous solution of sodium hexahydroxy platinate hydrate (Na₂[Pt(OH)₆].nH₂O)) in the chemical liquid tank 47 is injected through the injection pipe 49 into the aqueous solution at 60° C. containing ammonia and flowing through the circulation pipe 31. The concentration of platinum ions in the aqueous solution to be injected is, for example, 1 ppm. In the aqueous solution of sodium hexahydroxy platinate hydrate, platinum is in an ionic state. The aqueous solution at 60° C. containing platinum ions and ammonia is supplied from the circulation pipe 31 to the cleanup system pipe 18 by driving the circulation pumps 34 and 35, and circulates in the closed-loop including the circulation pipe 31 and the cleanup system pipe 18.

Immediately after the start of injection, the injection rate of the aqueous solution of Na₂[Pt(OH)₆].nH₂O into the circulation pipe 31 is calculated in advance so that the platinum concentration at the connection point of the aqueous solution of Na₂[Pt(OH)₆].nH₂O injected into the circulation pipe 31 from the chemical liquid tank 47 through the connection point between the circulation pipe 31 and the injection pipe 49 becomes a set concentration, for example, 1 ppm, and further, the amount of the aqueous solution of Na₂[Pt(OH)₆].nH₂O to be filled in the chemical liquid tank 47, which is necessary for adhering a predetermined amount of platinum to the surface of the nickel metal film formed on the inner surface of the cleanup system pipe 18 is calculated with the concentration of platinum ions in the aqueous solution at 60° C. containing ammonia and flowing in the circulation pipe 31 as the set concentration. The calculated amount of the aqueous solution of Na₂[Pt(OH)₆].nH₂O is filled in the chemical liquid tank 47. The rotation speed of the injection pump 48 is controlled according to the calculated injection rate of the aqueous solution of Na₂[Pt(OH)₆].nH₂O into the circulation pipe 31, and the aqueous solution of Na₂[Pt(OH)₆].nH₂O in the chemical liquid tank 47 is injected into the circulation pipe 31.

The reducing agent is injected (step S10). The valve 45 of the reducing agent injection device 41 is opened to drive the injection pump 43, and the aqueous solution of hydrazine, which is a reducing agent in the chemical liquid tank 42, is injected into the aqueous solution at 60° C. containing platinum ions and ammonia and flowing in the circulation pipe 31 through the injection pipe 44. The hydrazine concentration in the injected hydrazine aqueous solution is, for example, 100 ppm.

The hydrazine aqueous solution is injected into the circulation pipe 31 after the aqueous solution at 60° C. containing ammonia and Na₂[Pt(OH)₆].nH₂O reaches the connection point between the injection pipe 44 and the circulation pipe 31, which is the injection point of the hydrazine aqueous solution. Here, the aqueous solution at 60° C. containing platinum ions, hydrazine, and ammonia is supplied from the circulation pipe 31 to the cleanup system pipe 18. However, more preferably, the hydrazine aqueous solution is injected into the circulation pipe 31 immediately after all the predetermined amount of the aqueous solution of Na₂[Pt(OH)₆].nH₂O filled in the chemical liquid tank 47 have been injected into the circulation pipe 31. Here, the aqueous solution at 60° C. containing ammonia and platinum ions is supplied from the circulation pipe 31 to the cleanup system pipe 18, and after the injection of the platinum ion aqueous solution into the circulation pipe 31 is completed, the aqueous solution at 60° C. containing platinum ions, hydrazine, and ammonia (see FIG. 6) is supplied from the circulation pipe 31 to the cleanup system pipe 18.

In the case of the former injection of the hydrazine aqueous solution, the reduction reaction of converting platinum ions to platinum by hydrazine first occurs in the aqueous solution containing hydrazine and platinum ions and flowing in the circulation pipe 31, whereas in the case of the latter injection of the hydrazine aqueous solution, since platinum ions are already adsorbed on the surface of the nickel metal film 91 formed on the inner surface of the cleanup system pipe 18 and the adsorbed platinum ions are reduced by hydrazine, the amount of platinum 92 adhering to the surface of the nickel metal film 91 formed on the inner surface of the cleanup system pipe 18 is further increased (see FIG. 6).

Immediately after the start of injection of the hydrazine aqueous solution, the injection rate of the hydrazine aqueous solution into the circulation pipe 31 is calculated in advance so that the hydrazine concentration at the connection point of the hydrazine aqueous solution injected from the chemical liquid tank 42 through the connection point between the circulation pipe 31 and the injection pipe 44 becomes a set concentration, for example, 100 ppm, and then the amount of the hydrazine aqueous solution to be filled in the chemical liquid tank 42 required to reduce the platinum ions adsorbed on the surface of the nickel metal film 91 formed on the inner surface of the cleanup system pipe 18 to the platinum 92 is calculated with the hydrazine in the aqueous solution at 60° C. containing platinum ions and flowing in the circulation pipe 31 as the set concentration, and the calculated amount of the hydrazine aqueous solution was filled into the chemical liquid tank 42. The rotation speed of the injection pump 43 is controlled according to the calculated injection rate of the hydrazine aqueous solution into the circulation pipe 31, and the hydrazine aqueous solution in the chemical liquid tank 42 is injected into the circulation pipe 31.

When the entire amount of the aqueous solution of Na₂[Pt(OH)₆].nH₂O (aqueous solution containing platinum ions) in the chemical liquid tank 47 has been injected into the circulation pipe 31, the injection pump 48 is stopped and the valve 50 is closed. As a result, the injection of the aqueous solution containing platinum ions into the circulation pipe 31 is stopped. When the entire amount of the hydrazine aqueous solution (reducing agent aqueous solution) in the chemical liquid tank 42 has been injected into the circulation pipe 31, the injection pump 43 is stopped and the valve 45 is closed. As a result, the injection of the hydrazine aqueous solution into the circulation pipe 31 is stopped.

Since the platinum ions adsorbed on the surface of the nickel metal film 91 are reduced by the injected hydrazine to become platinum 92, the platinum 92 adheres to the surface of the nickel metal film 91 formed on the inner surface of the cleanup system pipe 18 (See FIG. 6).

In the example, ammonia contained in the aqueous solution 94 that contacts the nickel metal film 91 reacts with a trace amount of iron ions (Fe³⁺) contained in the aqueous solution 94 to generate iron-ammonia complex ions. Therefore, the iron ion concentration in the aqueous solution 94 decreases and the iron ions contained in the aqueous solution 94 do not precipitate as iron hydroxide and magnetite. The platinum ions contained in the aqueous solution 94 do not adhere to iron hydroxide and magnetite as platinum, and the amount of platinum adhering to the nickel metal film 91 increases.

It is determined whether the adhesion of platinum is completed (step S11). When the elapsed time from the injection of the platinum ion aqueous solution and the reducing agent aqueous solution reaches a predetermined time, it is determined that the adhesion of the predetermined amount of platinum 92 to the surface of the nickel metal film 91 formed on the inner surface of the cleanup system pipe 18 is completed. When the elapsed time does not reach the predetermined time, each process of steps S9 to S11 is repeated.

The aqueous solution remaining in the cleanup system pipe 18 and the circulation pipe 31 is purified (step S12). After it is determined that the adhesion of platinum 92 to the surface of the nickel metal film 91 formed on the inner surface of the cleanup system pipe 18 is completed, the valve 72 is opened to close a part of the opening degree of the valve 69, and the aqueous solution 94 at 60° C. containing platinum ions, hydrazine, and ammonia and boosted by the circulation pump 35 is supplied to the mixed bed resin tower 54. Platinum ions, other metal cations (for example, sodium ions), hydrazine, ammonia, and OH groups contained in the aqueous solution 94 are adsorbed on the ion exchange resin in the mixed bed resin tower 54 and removed from the aqueous solution 94 (Second purification process).

The waste is disposed (step S13). After the second purification process is completed, the circulation pipe 31 and the waste disposal device (not shown) are connected by a high-pressure hose (not shown) including a pump (not shown). After the completion of the second purification process, the aqueous solution which is a radioactive waste remaining in the cleanup system pipe 18 and the circulation pipe 31 is discharged to the waste disposal device (not shown) from the circulation pipe 31 through the high-pressure hose by driving the pump and is disposed by a waste disposal device. After the aqueous solution in the cleanup system pipe 18 and the circulation pipe 31 is discharged, the cleaning water is supplied into the cleanup system pipe 18 and the circulation pipe 31, and the circulation pumps 34 and 35 are driven to clean the inside of these pipes. After the cleaning is completed, the cleaning water in the cleanup system pipe 18 and the circulation pipe 31 is discharged to the above waste disposal device.

As described above, each process of the formation of the nickel metal film 91 on the inner surface of the cleanup system pipe 18 in the portion between the valve 23 and the valve 25 upstream of the non-regenerative heat exchanger 21, and the adhesion of platinum 92 on the nickel metal film 91 is completed. The nickel metal film 91 to which platinum 92 has adhered is not formed on the inner surface of the cleanup system pipe 18 in the portion downstream of the valve 25.

The film-forming apparatus is removed from the piping system (step S14). After each process of steps S1 to S13 is performed, the film-forming apparatus 30 is removed from the cleanup system pipe 18, and the cleanup system pipe 18 is restored.

According to the Example, since an iron elution accelerator aqueous solution, for example, the iron elution accelerator aqueous solution containing 3000 ppm of formic acid and 1500 ppm of hydrogen peroxide is brought into contact with the inner surface of the cleanup system pipe 18, iron (II) ions are eluted from the cleanup system pipe 18 into the iron elution accelerator aqueous solution by the action of formic acid, and due to the catalytic action of the iron (II) ions, hydroxyl radicals are generated in the iron elution accelerator aqueous solution from hydrogen peroxide contained in the iron elution accelerator aqueous solution. In addition to the action of formic acid, hydroxyl radicals act on the inner surface of the cleanup system pipe 18, and thus, iron (II) ions are further eluted from the cleanup system pipe 18 to the film-forming aqueous solution 93. That is, the amount of iron (II) ions eluted from the cleanup system pipe 18 to the film-forming aqueous solution 93 increases. As the amount of iron (II) ions eluted increases, the amount of electrons generated also increases. When the nickel formate aqueous solution is injected into the iron elution accelerator aqueous solution to generate a film-forming aqueous solution and the film-forming aqueous solution is brought into contact with the inner surface of the cleanup system pipe 18, the amount of nickel ions incorporated into the inner surface of the cleanup system pipe 18 is increased. The nickel ions incorporated into the inner surface of the cleanup system pipe 18 become nickel metal on the inner surface of the cleanup system pipe 18 due to the action of a large amount of electrons generated. Therefore, the amount of the nickel metal film 91 formed on the inner surface of the cleanup system pipe 18 is remarkably increased. Then, the time required to complete the formation of the nickel metal film 91 on the inner surface of the cleanup system pipe 18 is remarkably shortened.

The concentration of formic acid contained in the iron elution accelerator aqueous solution in the example is lower than the concentration of formic acid contained in the surface cleaning agent aqueous solution that contacts the inner surface of the cleanup system pipe 18 in Japanese Patent Application No. 2019-19704. However, since the hydroxyl radicals generated from hydrogen peroxide contained in the film-forming aqueous solution by the catalytic action of iron (II) ions eluted into the film-forming aqueous solution acts on the inner surface of the cleanup system pipe 18, the amount of iron (II) ions eluted into the film-forming aqueous solution from the cleanup system pipe 18 and the amount of electrons generated by the elution of iron (II) ions are large. Thus, the amount of nickel metal film formed on the inner surface of the cleanup system pipe 18 will be about the same as the amount in Japanese Patent Application No. 2019-19704.

In the example, since the elution of iron (II) ions from the cleanup system pipe 18 can be promoted by the action of hydroxyl radicals generated from hydrogen peroxide, the concentration of formic acid contained in the iron elution accelerator aqueous solution (for example, 3000 ppm) is reduced to about 1/10 of the concentration of formic acid (for example, 30000 ppm) contained in the surface cleaning agent aqueous solution that contacts the inner surface of the cleanup system pipe 18, described in the specification of Japanese Patent Application No. 2019-19704. Therefore, the time required for the decomposition of formic acid contained in the film-forming aqueous solution 93, which is performed after the formation of the nickel metal film on the inner surface of the cleanup system pipe 18, in the example, is remarkably shortened than the time required for the decomposition of formic acid contained in the film-forming aqueous solution, which is performed after the formation of the nickel metal film on the inner surface of the cleanup system pipe 18, in Japanese Patent Application No. 2019-19704.

Therefore, the time required for the work of adhering noble metal to a carbon steel member of a nuclear power plant in the example can be further shortened than the time required in Japanese Patent Application No. 2019-19704.

In the example, since the nickel metal film 91 is formed on the inner surface of the cleanup system pipe 18 after the reduction decontamination of the inner surface thereof is completed, the adhesion between the cleanup system pipe 18 and the nickel metal film 91 is improved, and the nickel metal film 91 can be prevented from peeling off from the inner surface of the cleanup system pipe 18. The nickel metal generated by the action of electrons from the nickel ions incorporated into the cleanup system pipe 18 by the substitution reaction has very strong adhesion to the base material of the cleanup system pipe 18. Therefore, the nickel metal film 91 does not peel off from the cleanup system pipe 18.

In the example, since the process of step S3 (injection of the iron elution accelerator) is performed before the process of step S4 (injection of the nickel ion aqueous solution) is performed, impurities (for example, iron hydroxide) remaining in the inner surface of the cleanup system pipe 18 after the chemical decontamination is completed can be removed by the action of formic acid and hydroxyl radicals, the adhesion between the nickel metal film 91 and the cleanup system pipe 18 can be improved, and elution of iron (II) ions from the cleanup system pipe 18 can be promoted.

In the example, since ammonia, which is a complex ion forming agent, is injected into the film-forming aqueous solution 93, Fe (III) ions generated by the dissolution of the oxide film on the inner surface of the cleanup system pipe 18 by chemical decontamination react with the injected ammonia to generate ammonia complex ions of Fe (III) ions. The solubility of the ammonia complex ion of Fe (III) ion is higher than that of Fe (III) ion. As a result, when the aqueous solution containing Na₂[Pt(OH)₆].nH₂O) and hydrazine (reducing agent) are injected into the film-forming aqueous solution 94 containing ammonia in order to adhere platinum 92 to the surface of the nickel metal film 91 formed on the inner surface of the cleanup system pipe 18, even if the pH of the film-forming aqueous solution 94 rises due to the action of the hydrazine, Fe (III) ions in the film-forming aqueous solution can be significantly prevented from being precipitated as iron hydroxide and magnetite. Therefore, the amount of platinum ions contained in the film-forming aqueous solution 94 adsorbed on the surface of the nickel metal film 91 and adhered to the surface of the nickel metal film 91 as platinum 92 by the action of hydrazine is remarkably increased, and the time required for a predetermined amount of platinum 92 to adhere to the surface of the nickel metal film 91 is shortened.

### Example 2

The method for adhering noble metal to a carbon steel member of a nuclear power plant of Example 2, which is another preferred embodiment of the present invention, will be described with reference to FIGS. 8, 2, and 9. The method for adhering noble metal to a carbon steel member of a nuclear power plant of the example is applied to a carbon steel cleanup system pipe (carbon steel member) of a boiling-water nuclear power plant (BWR plant).

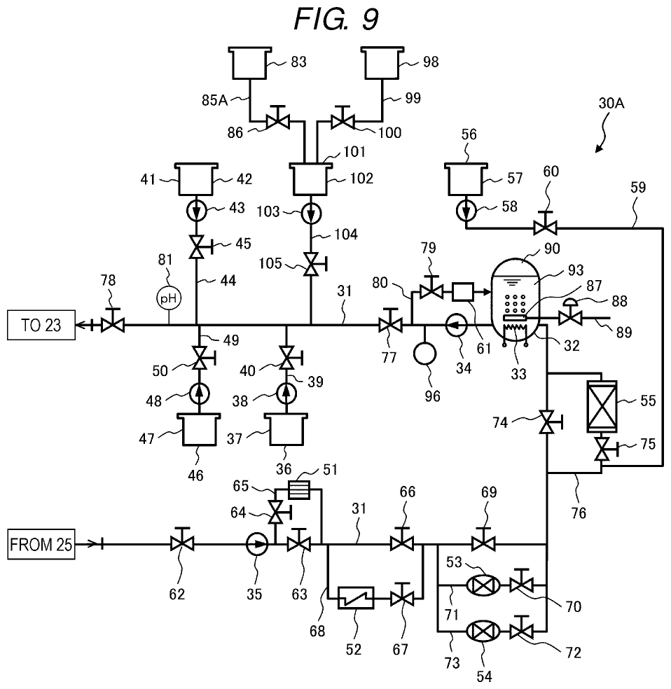

In the example, a film-forming apparatus 30A shown in FIG. 9 is used instead of the film-forming apparatus 30 used in Example 1. The configuration of the film-forming apparatus 30A will be described below.

The film-forming apparatus 30A has a configuration in which the formic acid injection device 82 is replaced with an iron dissolution accelerator injection device 101 in the film-forming apparatus 30. The configuration of the film-forming apparatus 30A other than the iron dissolution accelerator injection device 101 is the same as the configuration of the film-forming apparatus 30 excluding the formic acid injection device 82.

The iron dissolution accelerator injection device 101 includes a formic acid supply device, a hydrogen peroxide supply device, a chemical liquid tank 102, an injection pump 103, and an injection pipe 104. The formic acid supply device includes the chemical liquid tank 83 and a supply pipe 85A. The chemical liquid tank 83 to be filled with the formic acid aqueous solution is connected to the chemical liquid tank 102 by the supply pipe 85A provided with the valve 86. The hydrogen peroxide supply device includes a chemical liquid tank 98 and a supply pipe 99. The chemical liquid tank 98 to be filled with the hydrogen peroxide aqueous solution is connected to the chemical liquid tank 102 by the supply pipe 99 provided with a valve 100. The chemical liquid tank 102 is connected to the circulation pipe 31 by the injection pipe 104 provided with the injection pump 103 and a valve 105. The injection pipes 104, 39, 49, and 44 are connected to the circulation pipe 31 between the valve 77 and the on-off valve 78 in that order from the valve 77 toward the on-off valve 78.

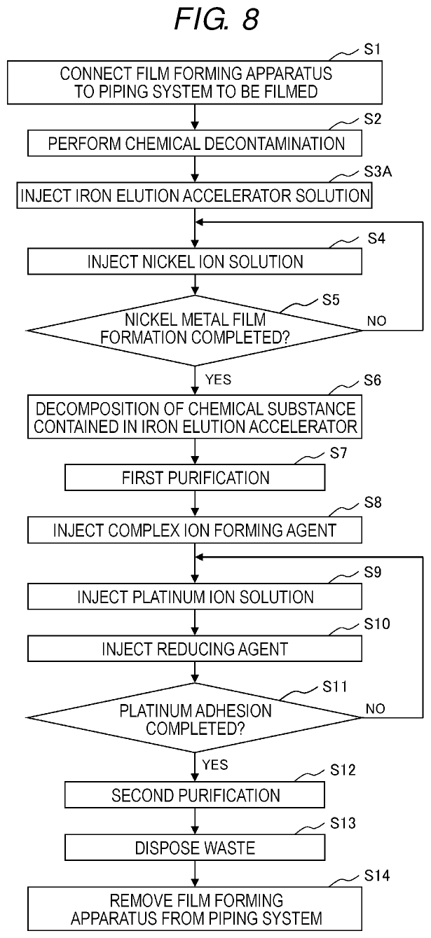

In the method for adhering noble metal to a carbon steel member of a nuclear power plant of the present example, among steps S1 to S14 performed by the method for adhering noble metal to a carbon steel member of a nuclear power plant of Example 1, the process of step S3 is replaced with the process of step S3A shown in FIG. 8. That is, in the example, each process of steps S1, S2, S3A, and S4 to S14 shown in FIG. 8 is performed.

In the process of step S1 of the present example, when the operation of the BWR plant 1 is stopped, one end of the circulation pipe 31 of the film-forming apparatus 30A on the on-off valve 78 side is connected to the flange of the valve 23 as in Example 1. The other end of the circulation pipe 31 of the film-forming apparatus 30A on the on-off valve 62 side is connected to the flange of the valve 25 as in Example 1. Both ends of the circulation pipe 31 are connected to the cleanup system pipe 18 and a closed-loop including the cleanup system pipe 18 and the circulation pipe 31 of the film-forming apparatus 30A is formed.

After the process of step S2 is performed, step S3A for injecting the iron elution accelerator is performed. Before performing the process of step S3A, the valve 86 is opened to supply the formic acid aqueous solution from the chemical liquid tank 83 into the chemical liquid tank 102. Here, the valve 105 is closed. Then, the valve 100 is opened to supply the hydrogen peroxide aqueous solution from the chemical liquid tank 98 into the chemical liquid tank 102. The formic acid aqueous solution and the hydrogen peroxide aqueous solution are mixed in the chemical liquid tank 102 to generate an iron elution accelerator aqueous solution in the chemical liquid tank 102.

The valve 105 is opened to drive the injection pump 103, and the iron elution accelerator aqueous solution in the chemical liquid tank 102 is injected into the aqueous solution at 90° C. having an extremely low concentration of formic acid and circulating through the injection pipe 104 to the circulation pipe 31, specifically, in the circulation pipe 31. The aqueous solution at 90° C. having an extremely low concentration of formic acid produces an iron elution accelerator aqueous solution at 90° C. containing, for example, formic acid at a concentration of 3000 ppm and hydrogen peroxide at a concentration of 1500 ppm in the circulation pipe 31 by the injection of the iron elution accelerator aqueous solution. The formic acid concentration in the formic acid aqueous solution in the chemical liquid tank 83, the supply amount of the formic acid aqueous solution from the chemical liquid tank 83 to the chemical liquid tank 102, the hydrogen peroxide concentration in the hydrogen peroxide aqueous solution in the chemical liquid tank 98, and the supply amount of the hydrogen peroxide aqueous solution from the chemical liquid tank 98 to the chemical liquid tank 102 are adjusted so that the iron elution accelerator aqueous solution at 90° C. containing formic acid at a concentration of 3000 ppm and hydrogen peroxide at a concentration of 1500 ppm is generated in the circulation pipe 31.

The iron elution accelerator aqueous solution at 90° C. in which the formic acid concentration is 3000 ppm and the hydrogen peroxide concentration is 1500 ppm is supplied from the circulation pipe 31 to the cleanup system pipe 18 and circulates in the closed-loop including the cleanup system pipe 18 and the circulation pipe 31. The iron elution accelerator aqueous solution comes into contact with the inner surface of the cleanup system pipe 18. The control of the rotation speed of the injection pump 103 can also adjust the formic acid concentration and the hydrogen peroxide concentration in the iron elution accelerator aqueous solution in the circulation pipe 31.

Hydroxyl radicals are generated from 1500 ppm of hydrogen peroxide by the catalytic action of iron (II) ions eluted from the cleanup system pipe 18 by the action of 3000 ppm of formic acid contained in the iron elution accelerator aqueous solution. The hydroxyl radical contained in the iron elution accelerator aqueous solution acts on the inner surface of the cleanup system pipe 18, thereby promoting the elution of iron (II) ions from the cleanup system pipe 18 into the iron elution accelerator aqueous solution. A large amount of electrons generated by promoting the elution of iron (II) ions are present in the iron elution accelerator aqueous solution. The iron elution accelerator aqueous solution circulating in the closed-loop is in contact with the inner surface of the cleanup system pipe 18 for 1 hour.

After 1 hour has passed since the iron elution accelerator aqueous solution came into contact with the inner surface of the cleanup system pipe 18, the injection of the hydrogen peroxide aqueous solution into the circulation pipe 31 is stopped, and a nickel formate aqueous solution is injected from the nickel ion injection device 36 into the iron elution accelerator aqueous solution at 90° C. having a formic acid concentration of 3000 ppm and a hydrogen peroxide concentration of 1500 ppm in the circulation pipe 31 (step S4). The film-forming aqueous solution 93 is produced by the injection of the nickel formate aqueous solution into the iron elution accelerator aqueous solution. The produced film-forming aqueous solution 93 has a nickel ion concentration of 400 ppm, a formic acid concentration of 3800 ppm, and a hydrogen peroxide concentration of 1500 ppm. The pH of the film-forming aqueous solution 93 is 2.5.

When the film-forming aqueous solution 93 comes into contact with the inner surface of the cleanup system pipe 18, hydroxyl radicals are generated in the film-forming aqueous solution 93 from hydrogen peroxide contained in the film-forming aqueous solution 93 due to the catalytic action of iron (II) ions eluted from the cleanup system pipe 18 by formic acid contained in the film-forming aqueous solution 93. By the action of these hydroxyl radicals, iron (II) ions are further eluted from the cleanup system pipe 18 to the film-forming aqueous solution 93. The substitution reaction between the nickel ions contained in the film-forming aqueous solution 93 and the iron (II) ions in the cleanup system pipe 18 is accelerated, and the amount of nickel ions incorporated into the inner surface of the cleanup system pipe 18 increases. The nickel ions incorporated into the inner surface of the cleanup system pipe 18 are reduced by a large amount of electrons generated by promoting the elution of iron (II) ions to become nickel metal. As a result, a nickel metal film is formed on the inner surface of the cleanup system pipe 18.

After that, when the determination in the process of step S5 is “YES”, the process of step S6 (decomposition of the chemical substances contained in the iron elution accelerator) is performed. In the process, formic acid, which is a chemical substance contained in the iron elution accelerator in the film-forming aqueous solution 93, is decomposed in the decomposition device 55. After the process of step S6 is completed, each process of steps S7 and S8 is performed. After that, each process of steps S9 (injection of platinum ion solution) and S10 (injection of reducing agent) is performed, and platinum 92 adheres to the surface of the nickel metal film formed on the inner surface of the cleanup system pipe 18. After that, each process of steps S11 to S14 is performed, and the work of adhering platinum to the inner surface of the cleanup system pipe 18 is completed.

In the example, each effect produced in Example 1 can be obtained.

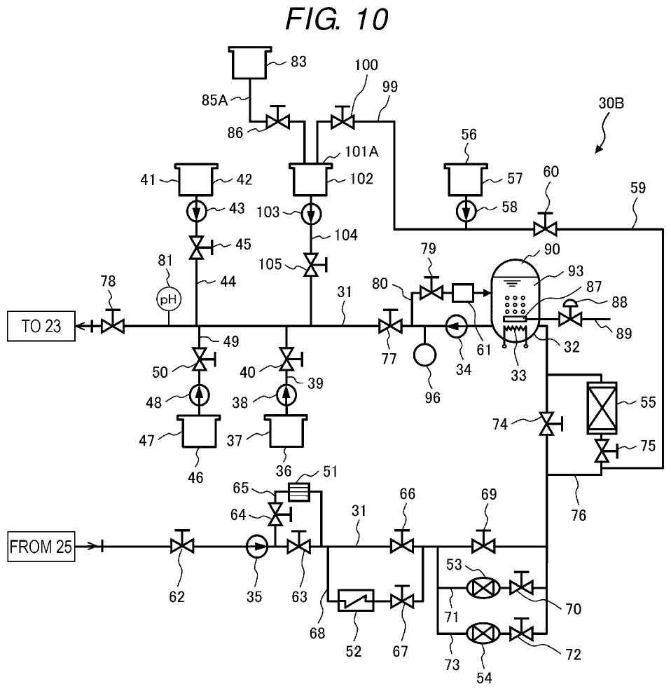

Instead of the film-forming apparatus 30A used in the example, a film-forming apparatus 30B shown in FIG. 10 may be used. In the film-forming apparatus 30B, the supply pipe 99 provided with the valve 100 and connected to the chemical liquid tank 102 is connected to the supply pipe 59 of the oxidizing agent supply device 56 instead of the chemical liquid tank 98. The supply pipe 99 is connected to the supply pipe 59 between the supply pump 58 and the valve 60. Here, the oxidizing agent supply device 56 is used as a hydrogen peroxide supply device in which the chemical liquid tank 57 is filled with a hydrogen peroxide aqueous solution.

In the method for adhering noble metal to a carbon steel member of a nuclear power plant using the film-forming apparatus 30B, the process of step S1 is performed when the operation of the BWR plant 1 is stopped. In the process of step S1, one end of the circulation pipe 31 of the film-forming apparatus 30B on the on-off valve 78 side is connected to the flange of the valve 23 as in Example 1. The other end of the circulation pipe 31 of the film-forming apparatus 30B on the on-off valve 62 side is connected to the flange of the valve 25 as in Example 1. As a result, both ends of the circulation pipe 31 are connected to the cleanup system pipe 18 and a closed-loop including the cleanup system pipe 18, and the circulation pipe 31 of the film-forming apparatus 30B is formed.

After the process of step S2 is performed, step S3A for injecting the iron elution accelerator using the film-forming apparatus 30B is performed. Before performing the process of step S3A, the valve 86 is opened to supply the formic acid aqueous solution from the chemical liquid tank 83 into the chemical liquid tank 102. Here, the valves 105 and 60 are closed. Then, the valve 100 is opened to drive the supply pump 58, and the hydrogen peroxide aqueous solution is supplied from the chemical liquid tank 57 into the chemical liquid tank 102. The formic acid aqueous solution and the hydrogen peroxide aqueous solution are mixed in the chemical liquid tank 102 to generate an iron elution accelerator aqueous solution in the chemical liquid tank 102.

Similar to the process of step S3A in Example 2 described above, the valve 105 is opened to drive the injection pump 103, and the iron elution accelerator aqueous solution in the chemical liquid tank 102 is injected into the circulation pipe 31 through the injection pipe 104. As a result, the iron elution accelerator aqueous solution at 90° C. containing formic acid having a concentration of 3000 ppm and hydrogen peroxide having a concentration of 1500 ppm is generated in the circulation pipe 31, and the iron elution accelerator aqueous solution is supplied from the circulation pipe 31 to the cleanup system pipe 18. Similar to Example 2, the contact of the iron elution accelerator aqueous solution to the inner surface of the cleanup system pipe 18 promotes the elution of iron (II) ions from the cleanup system pipe 18 to generate hydroxyl radicals, and a large amount of electrons are generated due to the elution of iron (II) ions.

The film-forming aqueous solution 93 generated by the injection of the nickel formate aqueous solution (step S4) comes into contact with the inner surface of the cleanup system pipe 18, and the nickel ions contained in the film-forming aqueous solution 93 are incorporated into the inner surface of the cleanup system pipe 18 by the substitution reaction as in Example 2. The incorporated nickel ions are reduced by the electrons generated by the elution of iron (II) ions to become nickel metal. As a result, a nickel metal film is formed on the inner surface of the cleanup system pipe 18.

Each process of steps S5 to S7 is performed. In the process of “decomposition of chemical substances contained in the iron elution accelerator” in step S6, the valve 60 is opened to drive the supply pump 58, and the hydrogen peroxide aqueous solution in the chemical liquid tank 57 is supplied to the decomposition device 55 instead of the chemical liquid tank 102. Here, the valve 100 is closed. Hydrogen peroxide contained in the hydrogen peroxide aqueous solution is used in the decomposition device 55 for the decomposition of formic acid, which is a chemical substance contained in the iron elution accelerator, together with the activated carbon catalyst in the decomposition device 55.

After that, each process of steps S8 to S14 is performed. By performing each process of steps S9 and S10, the platinum 92 adheres to the surface of the nickel metal film formed on the inner surface of the cleanup system pipe 18. When the process of step S14 is completed, the method for adhering noble metal to a carbon steel member of a nuclear power plant using the film-forming apparatus 30B is completed.

In the method for adhering noble metal to a carbon steel member of a nuclear power plant using the film-forming apparatus 30B, each effect produced in Example 2 can be obtained. Since the film-forming apparatus 30B is used in the method of adhering the noble metal, hydrogen peroxide contained in the hydrogen peroxide aqueous solution in the chemical liquid tank 57 of the film-forming apparatus 30B can be used as a raw material for generating hydroxyl radicals in each process of steps S3A and S4 and can be used for formic acid decomposition in the process of step S6. The chemical liquid tank 57 of the film-forming apparatus 30B is equivalent to sharing the chemical liquid tanks 57 and 98 of the film-forming apparatus 30A. Therefore, the structure of the film-forming apparatus 30B is simplified from the structure of the film-forming apparatus 30A.

### Example 3

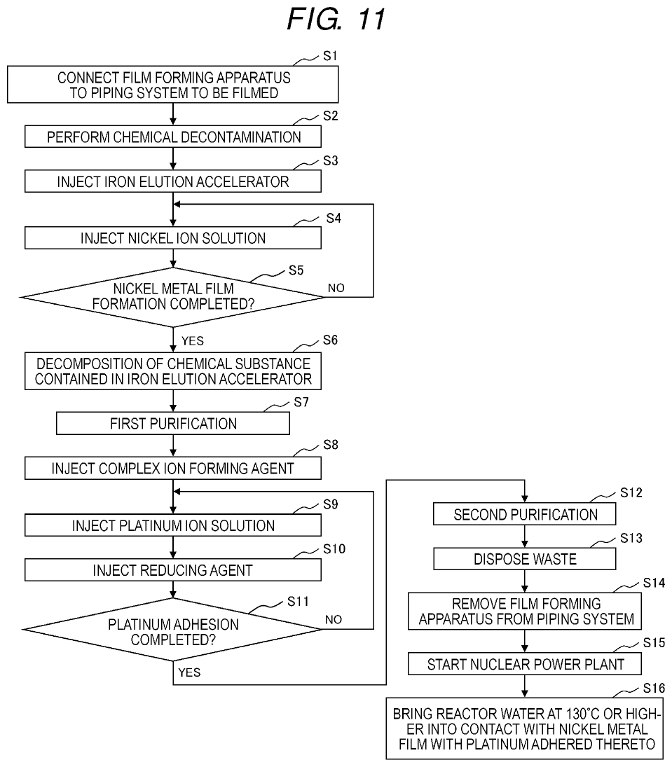

A method for preventing the adhesion of radionuclides to a carbon steel member of a nuclear power plant of Example 3, which is another suitable embodiment of the present invention and applied to a cleanup system pipe of a boiling-water nuclear power plant will be described with reference to FIG. 11. The method for preventing the adhesion of radionuclides to a carbon steel member of a nuclear power plant of the example is applied to a carbon steel cleanup system pipe (carbon steel member) of a BWR plant.

In the example, as shown in FIG. 11, each process of steps S1 to S14 in the method for adhering noble metal to a carbon steel member of a nuclear power plant of Example 1 (see FIG. 1), and newly added processes of steps S15 and S16 are performed. In the process of step S1, both ends of the circulation pipe 31 of the film-forming apparatus 30 are respectively connected to the cleanup system pipe 18 as shown in FIG. 2.

After each process of steps S1 to S14 is performed, each process of steps S15 and S16 is performed. Each process of steps S15 and S16, which is performed after the process of step S14 is completed, will be specifically described below.

The nuclear power plant is started (step S15). After the refueling and maintenance and inspection of the BWR plant 1 are completed, the BWR plant 1 including the cleanup system pipe 18 having the nickel metal film 91 to which the platinum 92 has been adhered formed on the inner surface thereof is started in order to start the operation in the next operation cycle.

The reactor water at 130° C. or higher is brought into contact with the nickel metal film to which platinum has been adhered (step S16). When the BWR plant 1 is started, the reactor water existing in the downcomer in the RPV 3 is supplied to the core 4 through the recirculation system pipe 6 and the jet pump 5 as described above. The reactor water discharged from the core is returned to the downcomer. The reactor water in the downcomer flows into the cleanup system pipe 18 via the recirculation system pipe 6, then flows into the feedwater pipe 11 and is returned to the RPV 3.

A control rod (not shown) is pulled out from the core 4, the core 4 changes from a subcritical state to a critical state and the reactor water in the core 4 is heated by the heat generated by the fission of the nuclear fuel material in the fuel rod. No steam is generated in the core 4. The control rod is pulled out from the core 4, and in the process of raising the temperature and boosting the pressure of the reactor 2, the pressure in the RPV 3 is raised to the rated pressure, and the heat generated by the nuclear fission heats the reactor water to make the temperature of the reactor water in the RPV 3 become the rated temperature (280° C.). After the pressure in the RPV 3 reaches the rated pressure and the reactor water temperature rises to the rated temperature, the reactor output is increased to the rated output (100% output) by further pulling out the control rod from the core 4 and increasing the flow rate of the reactor water fed to the core 4. The rated operation of the BWR plant 1, which maintains the rated output, is continued until the end of the operation cycle. When the reactor output rises to, for example, 10% output, the steam generated in the core 4 is supplied to the turbine 9 through the main steam pipe 8 to start power generation.

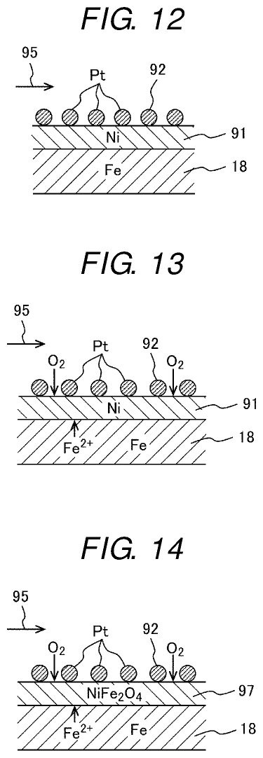

The reactor water contains oxygen and hydrogen peroxide generated by the radiolysis of the reactor water in RPV 3. The oxygen-containing reactor water 95 in the RPV 3 is guided from the recirculation system pipe 6 into the cleanup system pipe 18 in a state where the cleanup system pump 19 is driven and comes into contact with the nickel metal film 91 having platinum 92 adhered thereto and formed on the inner surface of the cleanup system pipe 18 (see FIG. 12). Due to the heating of the reactor water 95 by the heat generated by the above-mentioned nuclear fission, the temperature of the reactor water 95 that contacts the nickel metal film 91 rises and eventually reaches 130° C. or higher, and finally 280° C. at the rated output.

The temperature of the reactor water 95 differs greatly before and after the regenerative heat exchanger 20 and the non-regenerative heat exchanger 21. When the temperature of the reactor water in the RPV 3 is 280° C., the reactor water 95 at about 280° C. flows in the portion of the cleanup system pipe 18 upstream of the regenerative heat exchanger 20. As a result of heat exchange in the regenerative heat exchanger 20, the temperature of the reactor water 95 flowing out from the regenerative heat exchanger 20 to the valve 25 side drops to a range of about 200° C. to 150° C. In the non-regenerative heat exchanger 21, the temperature of the reactor water 95 drops to a range of 50° C. to about room temperature, and the reactor water 95 is supplied to the reactor water cleanup apparatus 22 including the ion exchange resin within the temperature range. Since the reactor water 95 flowing out of the reactor water cleanup apparatus 22 is used as feedwater, it is heated in the range of 150° C. to about 200° C. by the regenerative heat exchanger 20 and then joins the feedwater flowing through the feedwater pipe 11.

During the period when the BWR plant 1 is started and the pressure in the RPV 3 rises to the rated pressure (the temperature of the reactor water here is 280° C.), the reactor water 95 flowing in the portion of the cleanup system pipe 18 between the valve 23 and the regenerative heat exchanger 20, the reactor water 95 flowing in the portion of the cleanup system pipe 18 between the regenerative heat exchanger 20 and the valve 25, and the reactor water 95 flowing in the portion of the cleanup system pipe 18 that is closer to the feedwater pipe 11 than the regenerative heat exchanger 20 reaches a temperature of 130° C. or higher, although there is a time lag. In the process of raising the temperature and boosting the pressure of the reactor 2, the temperature of the reactor water 95 in the RPV 3 rises to a higher temperature exceeding 130° C. as the pressure in the RPV 3 rises.

Therefore, the surface of the nickel metal film 91 having platinum 92 adhered thereto, which is formed on the inner surface of the cleanup system pipe 18 between the valve 23 and the valve 25, is brought into contact with the oxygen-containing reactor water 95 at a temperature within the temperature range of 130° C. or higher and 280° C. or lower, and thus, the cleanup system pipe 18 and its nickel metal film 91 are heated to the same temperature as the reactor water 95. Oxygen contained in the reactor water 95 moves into the nickel metal film 91 formed on the inner surface of the cleanup system pipe 18 between the valve 23 and the valve 25, and Fe contained in the cleanup system pipe 18 which is a carbon steel member becomes Fe²⁺ and moves into the nickel metal film 91 (see FIG. 13). In a high-temperature environment in the temperature range of 130° C. or higher and 280° C. or lower, oxygen contained in the reactor water 95 and Fe²⁺ from the cleanup system pipe 18 are likely to move into the nickel metal film 91. When the oxygen concentration in the reactor water 95 is low, the water molecules of the reactor water 95 are decomposed by the corrosion of iron to generate oxygen, and the oxygen has the same function as oxygen contained in the above-mentioned reactor water 95. Due to the action of platinum 92 adhered to the nickel metal film 91, the corrosion potentials of the cleanup system pipe 18 and the nickel metal film 91 are lowered, and a high-temperature environment within the temperature range of 130° C. or higher and 280° C. or lower is formed, and thus, the nickel metal film 91 reacts with oxygen and Fe²⁺ transferred into the nickel metal film 91 to produce stable nickel ferrite (NiFe₂O₄) in which x is 0 in Ni₁₋ₓFe₂₊ₓO₄.

In the process of raising the temperature and boosting the pressure, hydrogen is injected into the feedwater flowing through the feedwater pipe 11 by a hydrogen injection device (not shown) connected to the feedwater pipe 11 between the condensate pump 12 and the condensate polisher 13, at the stage before the temperature of the reactor water 95 reaches 130° C. The hydrogen injection is performed during the process of raising the temperature and boosting the pressure, the reactor output raising process, and the rated operation of the BWR plant 1. Since the feedwater containing hydrogen is fed to the reactor pressure vessel 3, hydrogen is eventually injected into the reactor water. The decrease in the corrosion potentials of the cleanup system pipe 18 and the nickel metal film 91 due to the action of platinum 92 described above is caused by that oxygen contained in the reactor water 95 is reacted with the injected hydrogen to become water by the action of platinum 92.

When stable nickel ferrite is produced, the ease with which nickel and iron are incorporated into the ferrite structure is affected by platinum (noble metal) 92, and in the presence of platinum 92, nickel is more easily incorporated than iron. Therefore, stable nickel ferrite is produced in which x is 0 in Ni₁₋ₓFe₂₊ₓO₄. Then, the nickel metal film 91 formed on the inner surface of the cleanup system pipe 18 is converted into a stable nickel ferrite (NiFe₂O₄) film 97, and the inner surface of the cleanup system pipe 18 between the valve 23 and the valve 25 is covered with the stable nickel ferrite film 97 with platinum 92 adhered on the surface thereof (see FIG. 14).

In the example, each effect produced in Example 1 can be obtained. The example can also obtain the effects described below.

Nickel ferrite (NiFe₂O₄, in which X is 0 in Ni₁₋ₓFe₂₊ₓO₄), which has been produced as described above in a high-temperature environment in the temperature range of 130° C. or higher and 280° C. or lower from the nickel metal film 91 covering the inner surface of the cleanup system pipe 18 has a large crystal growth and is stable without being eluted into the water like the Ni_{0.7}Fe_{2.3}O₄ film even if noble metals adhere thereto, and the adhesion of radionuclides to carbon steel, which is the base material, that is, the cleanup system pipe 18 can be prevented.

According to the example, the nickel ferrite film 97 in which x is 0 in Ni₁₋ₓFe₂₊ₓO₄ and which is produced, as described above, from the nickel metal film 91 under the action of platinum 92 adhering to the nickel metal film 91 and a high-temperature environment of 130° C. or higher and 280° C. or lower is a stable nickel ferrite film that does not elute into the reactor water with the action of the adhered platinum 92 even during the operation of the BWR plant 1. The stable nickel ferrite film 97 thus generated, which does not elute into the reactor water even with the action of the adhered platinum 92, can prevent the corrosion of the cleanup system pipe 18 for a longer period than the Ni_{0.7}Fe_{2.3}O₄ film formed in a low-temperature range of 60° C. to 100° C. Specifically, the stable nickel ferrite film 97 formed on the inner surface of the cleanup system pipe 18 is not eluted by the action of the adhered platinum 92 and can cover the inner surface of the cleanup system pipe 18 over a plurality of operation cycles, for example, five operation cycles (for example, for 5 years). As described above, since the stable nickel ferrite film 97 can cover the inner surface of the cleanup system pipe 18 for a long period of time, the cleanup system pipe 18 is prevented from the adhesion of radionuclides for a long period of time.

In the example, the nickel metal film 91 formed on the inner surface of the cleanup system pipe 18 not only shortens the time required for platinum to adhere to the cleanup system pipe 18 but also contributes to the formation of the stable nickel ferrite film 97 that does not elute into the reactor water even with the adhered platinum on the inner surface of the cleanup system pipe 18 in conjunction with the action of the adhered platinum 92. The nickel ferrite film 97 prevents the reactor water flowing in the cleanup system pipe 18 from coming into contact with the base material of the cleanup system pipe 18 after the BWR plant is started in the next operation cycle. Therefore, the corrosion of the cleanup system pipe 18 by the reactor water is prevented, and further, the radionuclides contained in the reactor water are not incorporated into the base material of the cleanup system pipe 18.

Each process of the steps S15 and S16 of the example may be performed following the process of step S14, after the process of step S14 of Example 2 is completed, and after the process of step S14 is completed in the method for adhering noble metal to a carbon steel member of a nuclear power plant using the film-forming apparatus 30B.

### Example 4

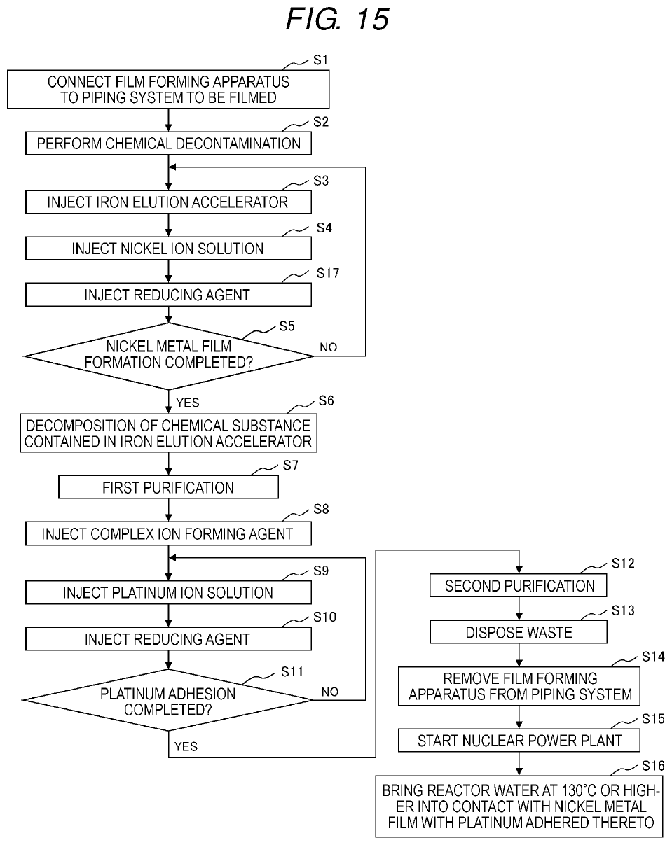

The method for preventing the adhesion of radionuclides to a carbon steel member of a nuclear power plant of Example 4, which is another preferred embodiment of the present invention, will be described with reference to FIGS. 2, 3, and 15. The method for preventing the adhesion of radionuclides to a carbon steel member of a nuclear power plant of the example is applied to a carbon steel cleanup system pipe of a BWR plant.

In the example, each process of steps S1 to S16 in the method for preventing the adhesion of radionuclides to a carbon steel member of a nuclear power plant of Example 3, and a new process of step S17 are performed. The process of step S17 is performed between the process of step S3 and the process of step S4. The method for preventing the adhesion of radionuclides to a carbon steel member of a nuclear power plant of the example includes a method for forming a nickel metal film on the carbon steel member of the nuclear power plant in which the processes of steps S1 to S4, S17, and S5 to S7 are performed.

In the process of step S1, the film-forming apparatus 30 is connected to the cleanup system pipe of the BWR plant. After each process of step S1 and step S2 is performed, the iron elution accelerator containing formic acid and hydrogen peroxide is injected (step S3). Similar to Example 1, the iron elution accelerator aqueous solution containing 3000 ppm formic acid and 1500 ppm hydrogen peroxide is injected from the chemical liquid tanks 83 and 57 into the aqueous solution at 90° C. containing the remaining formic acid and flowing through the circulation pipe 31. Iron (II) ions are eluted from the cleanup system pipe 18 into the iron elution accelerator aqueous solution by 3000 ppm of formic acid contained in the iron elution accelerator. Hydroxyl radicals are generated from 1500 ppm of hydrogen peroxide by the catalytic action of iron (II) ions, and the action of these hydroxyl radicals also promotes the elution of iron (II) ions from the cleanup system pipe 18 into the iron elution accelerator aqueous solution. A large amount of electrons are generated as the elution of iron (II) ions is promoted. For 1 hour, the iron elution accelerator aqueous solution comes into contact with the inner surface of the cleanup system pipe 18. During the period, a large amount of iron (II) ions are eluted from the cleanup system pipe 18 into the iron elution accelerator aqueous solution, and a large amount of electrons are generated.

The nickel ion aqueous solution is injected (step S4). By opening the valve 40 of the nickel ion injection device 36 and driving the injection pump 38, the nickel formate aqueous solution in the chemical liquid tank 37 is injected into the iron elution accelerator aqueous solution flowing in the circulation pipe 31. As a result of injecting the nickel formate aqueous solution into the iron elution accelerator aqueous solution, the film-forming aqueous solution 93 is generated in the circulation pipe 31. The film-forming aqueous solution 93 is a film-forming aqueous solution at 90° C. containing 3800 ppm of formic acid and 1500 ppm of hydrogen peroxide. Here, the concentration and injection amount of the nickel formate aqueous solution in the chemical liquid tank 37 are adjusted so that the nickel ion concentration in the circulating water flowing in the circulation pipe 31 into which the nickel formate aqueous solution has been injected is, for example, 500 ppm. Here, the pH of the circulating water flowing in the circulating pipe 31 into which the nickel formate aqueous solution has been injected is adjusted to be in the range of 2.5 to 4.0 (2.5 or more and 4.0 or less) as described above.

The film-forming aqueous solution (film-forming liquid) 93 at 90° C. containing nickel ions and formic acid and having a pH of 2.5 is supplied from the circulation pipe 31 to the cleanup system pipe 18 by driving the circulation pump 34. When the film-forming aqueous solution 93 comes into contact with the inner surface of the cleanup system pipe 18, the nickel metal film 91 is formed on the inner surface of the cleanup system pipe 18 as in Example 1. Due to the action of formic acid contained in the film-forming aqueous solution 93 and hydroxyl radicals generated from hydrogen peroxide, the elution of iron (II) ions into the film-forming aqueous solution 93 increases, and the amount of nickel ions incorporated into the inner surface of the cleanup system pipe 18 is increased by the above-mentioned substitution reaction. The nickel ions incorporated into the inner surface are reduced by a large amount of electrons generated by the elution of iron (II) ions to become nickel metal. Then, a nickel metal film 91 that covers the inner surface of the cleanup system pipe 18 is formed. The nickel metal film 91 contains, for example, nickel metal in the range of 500 μg or more and 4000 μg or less per square centimeter (500 to 4000 μg/cm²).

The reducing agent is injected (step S17). When the elapsed time from the injection of the nickel formate aqueous solution into the circulation pipe 31 reaches a set time (for example, 1 hour), the injection pump 84 and the supply pump 58 are stopped, the valves 86 and 60 are closed, and the injection of the formic acid aqueous solution and the aqueous hydrogen peroxide solution into the circulation pipe 31 is stopped. Then, an aqueous solution of hydrazine, which is a reducing agent, is injected from the reducing agent injection device 41 into the film-forming aqueous solution flowing in the circulation pipe 31. The hydrazine concentration in the injected hydrazine aqueous solution is, for example, 450 ppm. The residual hydrogen peroxide is decomposed by the injection of hydrazine and the film-forming aqueous solution becomes a film-forming aqueous solution containing nickel ions and hydrazine and having a pH in the range of 4.0 or more and 9.0 or less, specifically, the film-forming aqueous solution 93 at 90° C. containing nickel ions, formic acid, and hydrazine and having a pH of 6.

The film-forming aqueous solution 93 containing hydrazine, which is supplied to the cleanup system pipe 18, comes into contact with the surface of the nickel metal film 91. Nickel ions contained in the film-forming aqueous solution are adsorbed on the surface of the nickel metal film 91, and the nickel ions are reduced by hydrazine to become nickel metal. Since the film-forming aqueous solution 93 circulates in the closed-loop including the circulation pipe 31 and the cleanup system pipe 18, the nickel metal adhering to the surface of the nickel metal film 91 increases, and the thickness of the nickel metal film 91 formed on the inner surface of the cleanup system pipe 18 increases.

After the process of step S17 is completed, each process of steps S5 to S14 is performed. The implementation of each process of the steps S1 to S4, S17, and S5 to S14 corresponds to the implementation of one example of the method for adhering noble metal to a carbon steel member of a nuclear power plant. After the process of step S14 is completed, each process of steps S15 and S16 is performed in the same manner as in Example 3. By performing step S16, the nickel metal film 91 formed on the inner surface of the cleanup system pipe 18 is converted into the stable nickel ferrite film 97.

In the example, each effect produced in Example 3 can be obtained. In the example, since the process of injecting the reducing agent in step S17 is performed after injecting the nickel ion aqueous solution in step S4, a large amount of nickel ions incorporated into the inner surface of the cleanup system pipe 18 can be converted into nickel metal even when the nickel ion aqueous solution having a high nickel ion concentration is injected into the circulation pipe 31. That is, when an aqueous nickel ion solution having a high nickel ion concentration is injected into the circulation pipe 31, even if there is a shortage of electrons generated by elution of iron (II) ions to reduce nickel ions and convert them into nickel metal, threatening the conversion of nickel ions into nickel metal, the injected reducing agent (for example, hydrazine) is injected into the circulation pipe 31, and thus, a large amount of nickel ions incorporated onto the inner surface of the cleanup system pipe 18 can be converted into nickel metal. Therefore, the thickness of the nickel metal film 91 formed on the inner surface of the cleanup system pipe 18 can be increased.

In the example, since the reducing agent is injected into the film-forming liquid, hydrogen peroxide can be decomposed by the action of the reducing agent, and the supply of hydrogen peroxide to the cation exchange resin can be prevented in the formic acid decomposition process. Therefore, in the nickel metal film forming process, it is possible to supply a larger amount of hydrogen peroxide than in Example 1 and increase the amount of generated electrons. As a result, the amount of formed nickel metal film also increases.

In the example, step S3A shown in FIG. 8 may be performed instead of step S3 by using either the film-forming apparatus 30A or 30B.

Each of Examples 1 to 4 can be applied to a carbon steel pipe connected to a reactor pressure vessel in a pressurized water nuclear power plant. The temperature of the reactor water in the reactor pressure vessel of the pressurized water nuclear power plant is higher than the temperature of the reactor water in the reactor pressure vessel 3 of the boiling-water nuclear power plant.

What is claimed is:

1. A method for adhering noble metal to a carbon steel member of a nuclear power plant, the method comprising:
contacting a film-forming aqueous solution containing an iron elution accelerator containing an iron elution agent and hydrogen peroxide, and nickel ions to a first surface of a carbon steel member of the nuclear power plant that contacts reactor water to forma nickel metal film on the first surface; and
adhering noble metal to a second surface of the formed nickel metal film; wherein
the formation of the nickel metal film and the adhesion of the noble metal are performed after the stop of the operation of the nuclear power plant and before the start of the nuclear power plant.

2. The method for adhering noble metal to a carbon steel member of a nuclear power plant according to claim 1, wherein
before the film-forming aqueous solution is brought into contact with the first surface of the carbon steel member, an iron elution accelerator aqueous solution containing the iron elution accelerator containing the iron elution agent and hydrogen peroxide is brought into contact with the first surface of the carbon steel member.

3. The method for adhering noble metal to a carbon steel member of a nuclear power plant according to claim 2, wherein
the iron elution agent and hydrogen peroxide are separately injected into the iron elution accelerator aqueous solution.

4. The method for adhering noble metal to a carbon steel member of a nuclear power plant according to claim 2, wherein
the iron elution agent and hydrogen peroxide are mixed and injected into the iron elution accelerator aqueous solution.

5. The method for adhering noble metal to a carbon steel member of a nuclear power plant according to claim 1, wherein
any of formic acid, malonic acid, and ascorbic acid is used as the iron elution agent.

6. The method for adhering noble metal to a carbon steel member of a nuclear power plant according to claim 1, wherein
the formation of the nickel metal film is performed by reducing the nickel ions incorporated into the first surface of the carbon steel member by the electrons generated when iron ions are eluted from the carbon steel member by the action of the iron elution agent and the hydroxyl radicals generated from the hydrogen peroxide.

7. The method for adhering noble metal to a carbon steel member of a nuclear power plant according to claim 1, wherein
a pH of the film-forming aqueous solution containing the nickel ions and the iron elution accelerator is in the range of 2.5 or more and 4.0 or less.

8. The method for adhering noble metal to a carbon steel member of a nuclear power plant according to claim 1, wherein
the nickel metal film is formed after the first surface of the carbon steel member is subjected to reduction decontamination.

9. The method for adhering noble metal to a carbon steel member of a nuclear power plant according to claim 1, wherein
the iron elution agent contained in the film-forming aqueous solution is decomposed after the nickel metal film is formed on the first surface of the carbon steel member and before the noble metal adheres to the second surface of the nickel metal film.

10. A method of adhering noble metal to a carbon steel member of a nuclear power plant, the method comprising:
connecting a first pipe, which is connected to the reactor pressure vessel and a carbon steel member, to a second pipe different from the first pipe;
supplying a film-forming aqueous solution containing an iron elution accelerator containing an iron elution agent and hydrogen peroxide, and nickel ions to the first pipe through the second pipe;
contacting the film-forming aqueous solution to the inner surface of the first pipe to form a nickel metal film on the inner surface of the first pipe; and
supplying an aqueous solution containing noble metal from the second pipe to the first pipe to come into contact with the surface of the nickel metal film formed on the inner surface of the first pipe to adhere the noble metal to the surface of the nickel metal film.

11. The method for adhering noble metal to a carbon steel member of a nuclear power plant according to claim 10, wherein
before contacting the film-forming aqueous solution to the inner surface of the first pipe, the iron elution accelerator aqueous solution containing the iron elution accelerator containing the iron elution agent and hydrogen peroxide is supplied to the first pipe through the second pipe and the iron elution accelerator aqueous solution is brought into contact with the first surface of the carbon steel member.

12. The method for adhering noble metal to a carbon steel member of a nuclear power plant according to claim 11, wherein
the iron elution agent is injected into the second pipe from an iron elution agent injection device connected to the second pipe, the hydrogen peroxide is injected into the second pipe from a hydrogen peroxide injection device connected to the second pipe, and the nickel ions are injected into the second pipe from a nickel ion injection device connected to the second pipe, and
the film-forming aqueous solution supplied to the first pipe is generated in the second pipe by the iron elution agent, the hydrogen peroxide, and the nickel ions injected into the second pipe.

13. The method for adhering noble metal to a carbon steel member of a nuclear power plant according to claim 11, wherein
the iron elution accelerator containing the iron elution agent and hydrogen peroxide is injected into the second pipe from an iron elution accelerator injection device connected to the second pipe, and the nickel ions are injected into the second pipe from a nickel ion injection device connected to the second pipe, and
the film-forming aqueous solution supplied to the first pipe is generated in the second pipe by the iron elution accelerator and the nickel ions injected into the second pipe.

14. A method for preventing the adhesion of radionuclides to a carbon steel member of a nuclear power plant, the method comprising:
performing the method for adhering noble metal to a carbon steel member of a nuclear power plant according to claim 1; and
contacting water containing oxygen at a temperature in the temperature range of 130° C. or higher and 330° C. or lower to a second surface of a nickel metal film with the noble metal adhered thereto.

15. The method for preventing the adhesion of radionuclides to a carbon steel member of a nuclear power plant according to claim 14, wherein
after the noble metal adhered to a second surface of the nickel metal film, the nuclear power plant was started; and
reactor water is used as water containing oxygen at a temperature within the temperature range of 130° C. or higher and 330° C. or lower.
